(19) United States
(12) Patent Application Publication
(10) Pub. No.: US 2026/0058995 A1
(43) Pub. Date: Feb. 26, 2026

(54) DYNAMIC CYBERSECURITY POLICY MANAGEMENT BASED ON CONTEXTUAL ADAPTIVE LEARNING

(71) Applicants: SANTHOSH KUNJAPPAN PURATHEPPARAMBIL, milipitas, CA (US); ROHAN puri, san jose, CA (US); SAIRAMKUMAR VENKATARAMAN, los altos, CA (US)

(72) Inventors: SANTHOSH KUNJAPPAN PURATHEPPARAMBIL, milipitas, CA (US); ROHAN puri, san jose, CA (US); SAIRAMKUMAR VENKATARAMAN, los altos, CA (US)

(21) Appl. No.: 19/054,909

(22) Filed: Feb. 17, 2025

Related U.S. Application Data
(60) Provisional application No. 63/647,076, filed on May 13, 2024.

(51) Int. Cl. H04L 9/40

(52) U.S. Cl. CPC H04L 63/20

(57) ABSTRACT

A computerized system for dynamic cybersecurity policy using AI-based contextual adaptive learning includes an AI system that evaluates business contexts, risk tolerance, and productivity impact to generate threat intelligence assessments. The system includes a Contextual Adaptive Learning module that dynamically adjusts cybersecurity policies based on threat assessments to create security workflows. A Cybersecurity Mesh Development module that integrates policies across security frameworks. A Dynamic Scenario Catalog module that updates policy adjustments based on threat intelligence. An Automated Workflow Orchestration module that creates and refines security workflows for optimal efficiency. A Policy Recommendation and Automation module that generates prioritized security recommendations and automates policy changes based on organizational risk profiles and current security controls. This system harmonizes security policies while considering business context, risk, and productivity impacts.

### CLAIM OF PRIORITY

This application claims priority to U.S. Provisional Patent Application No. 63/647,076, filed on May 13, 2024 and titled DYNAMIC CYBERSECURITY POLICY MANAGEMENT BASED ON CONTEXTUAL ADAPTIVE LEARNING. This provisional application is hereby incorporated in its entirety.

### BACKGROUND

Conventional approaches to cybersecurity policy management face significant limitations in addressing the dynamic nature of modern security threats and organizational requirements. Organizations traditionally document their cybersecurity policies in static formats, implementing periodic reviews and updates on an annual or similar fixed schedule. These policies typically encompass multiple security domains including access control mechanisms, incident response procedures, data protection protocols, acceptable use guidelines, security awareness programs, and regulatory compliance frameworks. However, the practical implementation of these documented policies into operational security configurations frequently fails to achieve the intended security objectives.

This implementation gap creates substantial security exposures within organizational environments. Security control settings often deviate from established best practices, creating configuration vulnerabilities that can be exploited by malicious actors. Additionally, organizations frequently encounter coverage gaps wherein critical assets remain unprotected despite falling within the scope of security policies. Role-specific security measures may inadequately address the varying security requirements and awareness levels of different employee populations, further compromising the organization's security posture.

Multiple factors contribute to these implementation challenges. Organizations struggle to maintain comprehensive visibility across diverse security vendor solutions, making it difficult to identify and monitor potential exposures effectively. The inherent complexity of cybersecurity policies, combined with the intricate configuration requirements of modern security products, creates significant implementation hurdles for security administrators.

The prevalent multi-vendor ecosystem in organizational security environments introduces additional complications. Security solutions from different vendors may interact in unexpected ways, and administrators must understand the nuances of each solution's configuration options and their cross-system impacts. This challenge is compounded by vendors' frequent introduction of new features and setting updates, necessitating continuous configuration adjustments to maintain security effectiveness.

Furthermore, organizations face an overwhelming volume of potential security exposures. Common vulnerability enumerations (CVEs) alone often exceed an organization's practical remediation capacity, despite representing only a subset of the total exposure landscape. The frequent release of vendor updates, including new settings and features, adds complexity to the security management process and requires ongoing attention to maintain optimal protection levels.

Security administrators often demonstrate excessive caution regarding potential false positives and productivity disruptions. This cautious approach frequently results in security features being left disabled or inadequately configured, thereby limiting the effectiveness of deployed security solutions. As a consequence, organizations fail to realize the full protective potential of their cybersecurity investments.

Existing solutions have not adequately addressed the need for dynamic, adaptive security policy management. Current approaches lack the capability to continuously learn from evolving security landscapes, manage security exposures in real-time, and prioritize mitigation efforts based on contextual understanding of organizational requirements. This deficiency leaves organizations vulnerable to emerging threats and unable to maintain optimal security postures in rapidly changing technological environments.

Therefore, there exists a need for improved systems and methods that can provide dynamic, context-aware cybersecurity policy management while addressing the limitations of conventional approaches.

### BRIEF SUMMARY OF THE INVENTION

In accordance with one aspect of the present disclosure, a system and method for adaptive cybersecurity management can be implemented to address the complexity of modern security environments. The system can comprise an Adaptive Learning System that can be configured to dynamically identify, analyze, and mitigate security exposures and policy implementation gaps within organizational environments.

The system can be implemented to leverage rich contextual data sources, wherein dynamic inputs including security configurations, asset details, and incident records can be processed alongside static knowledge sources such as vendor best practices and compliance frameworks. A fine-tuned Large Language Model (LLM) can be integrated with a centralized policy hub, wherein modular workflows can be generated to address identified security exposures. The system can be configured to implement sophisticated prioritization logic that evaluates risks based on multiple factors including severity, business impact, and organizational priorities, enabling the generation of adaptive mitigation strategies that evolve with emerging threats and changing organizational requirements.

The system architecture can be implemented to include multiple integrated components. A workflow orchestration engine can be configured to automate the execution of security-related tasks, wherein data collection and contextualization modules can process incoming security information. An adaptive recommendation engine can be implemented to generate actionable insights based on the processed data. These components can be configured to work in concert to provide comprehensive end-to-end visibility into an organization's security posture.

The system can be further configured to bridge the gap between high-level cybersecurity policies and their practical implementation through automated policy validation and remediation workflows. Continuous feedback loops can be implemented to incorporate both user input and system performance metrics, wherein the accuracy and effectiveness of security recommendations can be continuously refined. This adaptive approach can enable real-time security posture management while minimizing the likelihood of unaddressed exposures.

Through this implementation, organizations can achieve enhanced visibility into their security environments, automate complex security management tasks, and maintain robust protection against evolving cyber threats. The system can provide a comprehensive solution for modern cybersecurity challenges, enabling efficient resource allocation and improved security outcomes through intelligent automation and contextual understanding.

In another aspect, a system for cybersecurity management leverages contextual adaptive learning to provide comprehensive security controls. The system implements three distinct layers working in concert: an interface layer, a memory layer, and a business layer. The interface layer comprises three key components: a UI portal for direct user interaction, an API component for programmatic access, and an AI chatbot for natural language interactions. The memory layer contains four essential storage and processing elements: a vector database for efficient data retrieval, a large language model component for AI processing, a relational database for structured data management, and a file storage system for unstructured data. The business layer operates as the system's core intelligence and connects directly to both the interface and memory layers. Within the business layer, an exposure management recommendations component analyzes cybersecurity threats to identify potential risks. The business layer also includes a security insights component that provides comprehensive visibility into the organization's security posture. Working alongside these components, an exposure validation and prioritization component helps assess and rank security concerns. A remediation automation component within the business layer handles automated security fixes and updates. The system employs a workflow orchestration and execution engine that manages the automation and execution of security workflows throughout the system. An adaptive learning system and recommendation engine powers the contextual recommendations that drive security improvements. The business layer also contains a data collection and context extraction system that transforms raw security data into structured, contextualized information. Through these integrated components, the system continuously refines security control settings by adapting to the organization's specific risk posture and appetite.

### BRIEF DESCRIPTION OF THE DRAWINGS

FIG. 1A illustrates another example system for dynamic cybersecurity policy management based on contextual adaptive learning, according to some embodiments.

FIG. 1B illustrates an example Adaptive Learning System and Recommendation Engine, according to some embodiments.

FIG. 1C illustrates an example Data Collection and Context Extraction, according to some embodiments.

FIG. 1D illustrates an example Workflow Orchestration and Execution Engine, according to some embodiments.

FIG. 2 is an example process for dynamic cybersecurity policy management based on contextual adaptive learning, according to some embodiments.

FIG. 3 illustrates an example process for implementing use cases in a dynamic cybersecurity policy management context, according to some embodiments.

FIG. 4 illustrates another example process, according to some embodiments.

FIG. 5 illustrates an example of comparing progress to three months previously to show the progress of an example security team, according to some embodiments.

FIG. 6 illustrates an example screenshot of an Executive Dashboard, according to some embodiments.

FIG. 7 illustrates an example screenshot of Configuration Health Summary, according to some embodiments.

FIG. 8 illustrates an example screenshot of Configuration Health Details, according to some embodiments.

FIG. 9 illustrates an example screenshot of a Coverage Dashboard, according to some embodiments.

FIG. 10 illustrates an example screenshot of Human risk dashboard, according to some embodiments.

FIG. 11 illustrates an example screenshot of Threat Exposure analysis, according to some embodiments.

FIG. 12 illustrates an example screenshot of MITRE Attack information, according to some embodiments.

FIG. 13 illustrates an example screenshot of MITRE Defend information, according to some embodiments.

FIG. 14 illustrates an example screenshot of Vendor Integrations, according to some embodiments.

FIG. 15 illustrates an example screenshot of Asset information, according to some embodiments.

FIG. 16 illustrates an example screenshot of an AI Studio-Work flow Example, according to some embodiments.

FIG. 17 illustrates an example screenshot of AI Studio-Studio design page, according to some embodiments.

FIG. 18 illustrates an example screenshot of Compliance information, according to some embodiments.

FIG. 19 illustrates an example screenshot of NIST-Compliance information, according to some embodiments.

FIG. 20 is a block diagram of a sample computing environment that can be utilized to implement various embodiments.

FIG. 21 illustrates an example system that features a dual-interface design for enhanced workflow management, according to some embodiments.

FIG. 22 illustrates an example system for implementing a cyber security platform, according to some embodiments.

The Figures described above are a representative set and are not an exhaustive with respect to embodying the invention.

### DESCRIPTION

Disclosed are a system, method, and article of manufacture for dynamic cybersecurity policy management based on contextual adaptive learning. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to ‘one embodiment,’ ‘an embodiment,’ ‘one example,’ or similar language means that a particular feature, structure, or characteristic described in connection with the embodiment is included in at least one embodiment, according to some embodiments. Thus, appearances of the phrases ‘in one embodiment,’ ‘in an embodiment,’ and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Definitions

Example definitions for some embodiments are now provided.

Chief information security officer (CISO) is a senior-level executive within an organization responsible for establishing and maintaining the enterprise vision, strategy, and program to ensure information assets and technologies are adequately protected. The CISO directs staff in identifying, developing, implementing, and maintaining processes across the enterprise to reduce information and information technology (IT) risks. They respond to incidents, establish appropriate standards and controls, manage security technologies, and direct the establishment and implementation of policies and procedures.

Cloud computing architecture refers to the components and subcomponents required for cloud computing. These components typically consist of a front-end platform (fat client, thin client, mobile), back-end platforms (servers, storage), a cloud-based delivery, and a network (Internet, Intranet, Intercloud). Combined, these components can make up cloud computing architecture.

Data ingestion can import large, assorted data files from one or more sources into a single, cloud-based storage medium (e.g. a data warehouse, data mart, database, etc.) to be analyzed.

Generative artificial intelligence (generative AI) is artificial intelligence capable of generating text, images, videos, or other data using generative models, often in response to prompts. Generative AI models learn the patterns and structure of their input training data and then generate new data that has similar characteristics.

Large language model (LLM) is a language model notable for its ability to achieve general-purpose language generation and other natural language processing tasks such as classification. LLMs acquire these abilities by learning statistical relationships from text documents during a computationally intensive self-supervised and semi-supervised training process. LLMs can be used for text generation, a form of generative AI, by taking an input text and repeatedly predicting the next token or word.

Mitre Corporation (MITRE) is an American not-for-profit organization with dual headquarters in Bedford, Massachusetts, and Mclean, Virginia. It manages federally funded research and development centers (FFRDCs) supporting various U.S. government agencies in the aviation, defense, healthcare, homeland security, and cybersecurity fields, among others.

Information security operations center (SOC) is a facility where enterprise information systems (e.g. web sites, applications, databases, data centers and servers, networks, desktops and other endpoints) are monitored, assessed, and defended.

### Example Systems and Methods

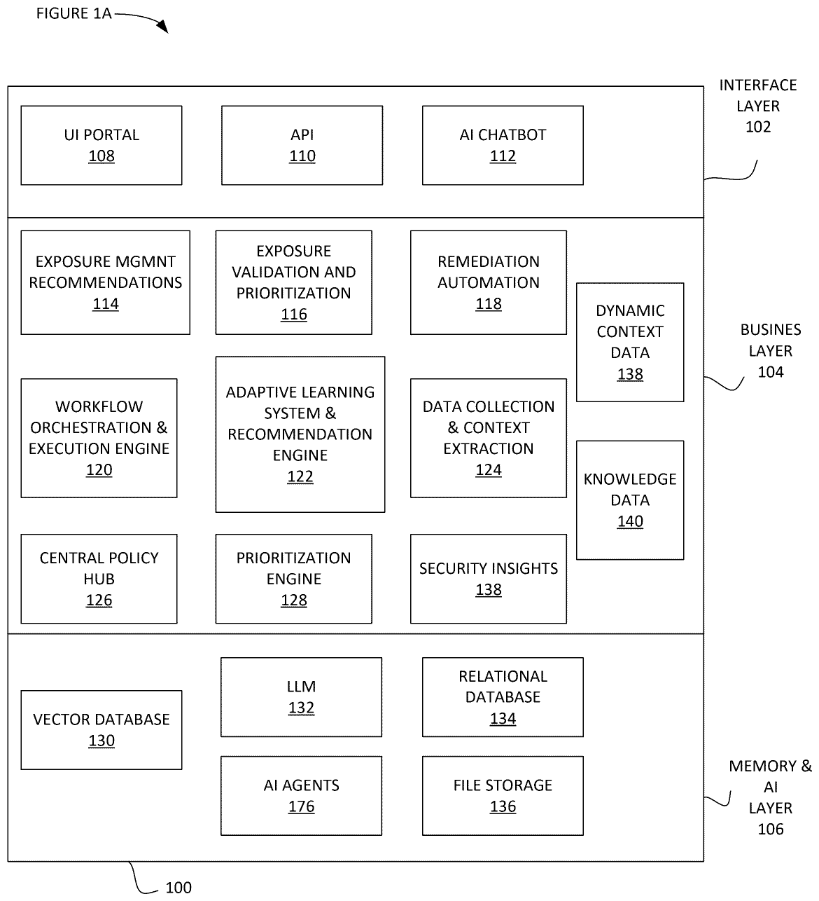

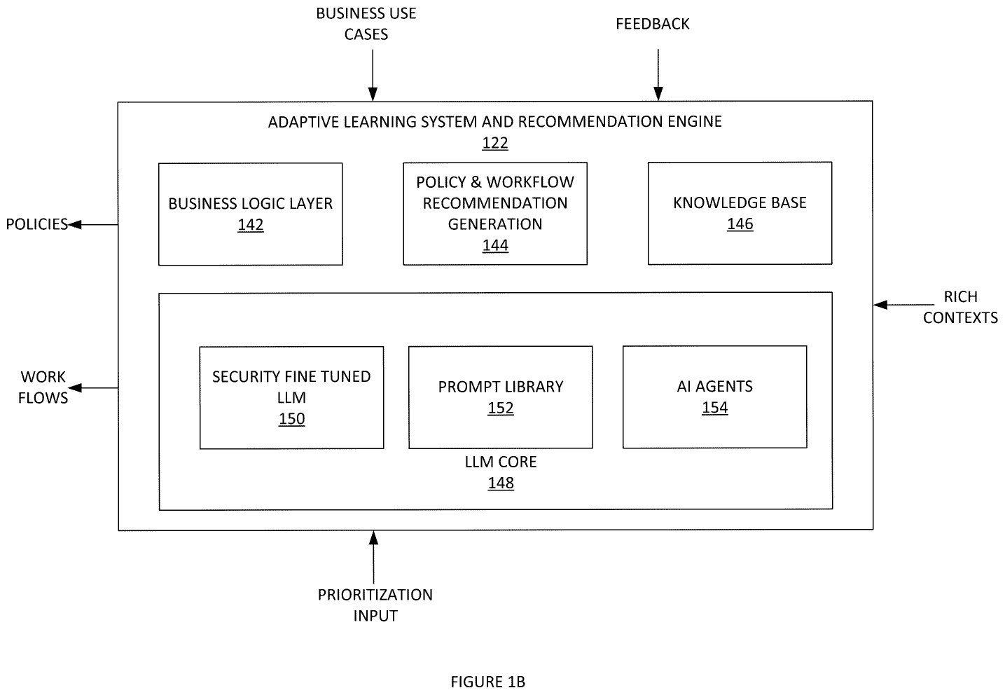

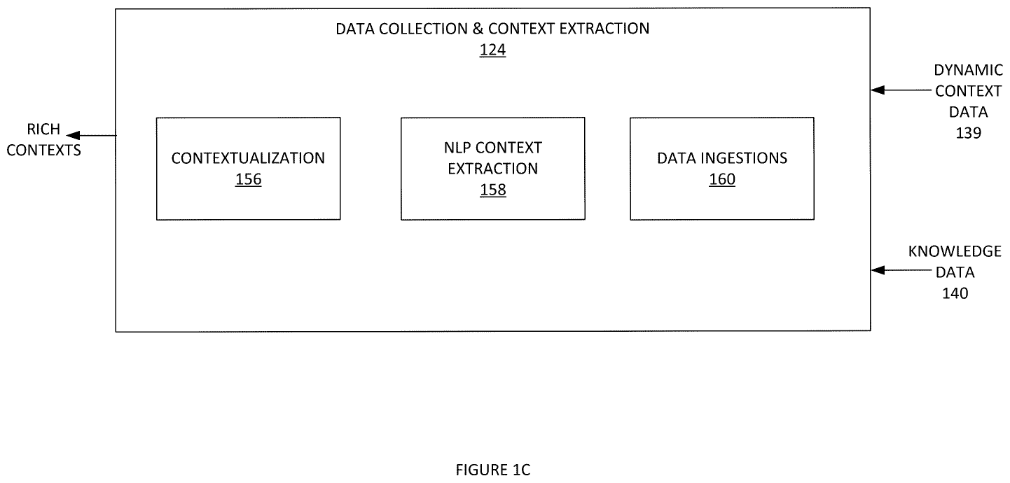

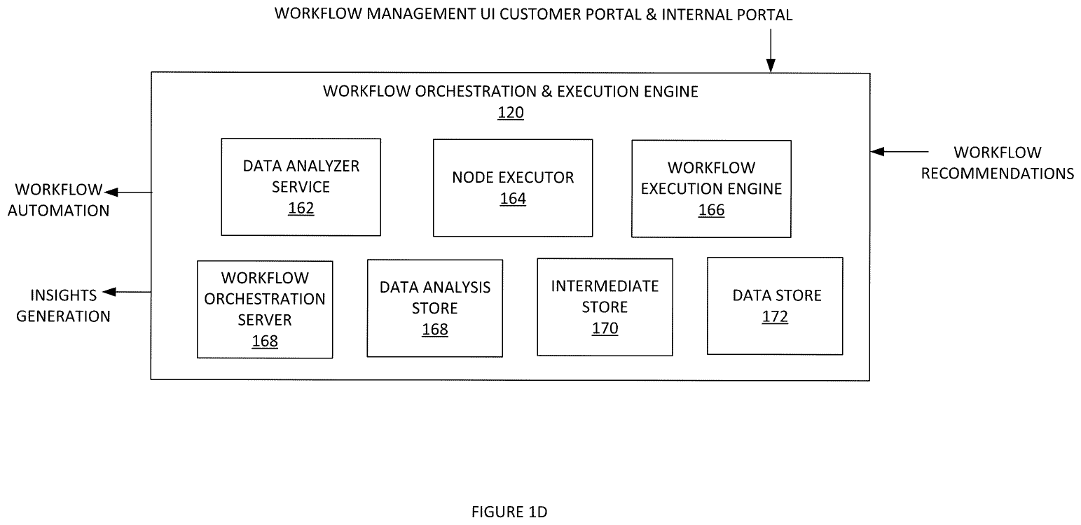

FIG. 1A illustrates another example system 100 for dynamic cybersecurity policy management based on contextual adaptive learning, according to some embodiments. System 100 can refine security control settings to align with the organization's risk posture and appetite. System 100 can tailor the Cybersecurity policy automatically, considering factors like existing security measures, budget, and the organization's activities. System 100 can provide SOC teams with prioritized tasks for adjusting security measures. System 100 can offer advanced alerts to the SOC team about potential cybersecurity and productivity risks associated with modifying security configurations. System 100 can gain insights into the deficiencies within the security policies, accompanied by detailed instructional guidance on remediation strategies. System 100 can achieve a comprehensive understanding of the security landscape by integrating security controls, vulnerabilities, and threats with established frameworks such as MITRE ATTACK and NIST, enhancing clarity on coverage. System 100 can facilitate the development of a Cybersecurity mesh by identifying opportunities for cross-product integration, aiming for improved security coherence and effectiveness.

More specifically, system 100 can be a platform is structured into three principal layers. Interface Layer 102 can encompass both the front end and API and serve as the point of interaction for users and applications. Business Layer 104 can be the core of the system, where information is processed, and knowledge and intelligence are generated to facilitate decision-making and actions. Memory and AI Layer 106 can act as the repository for all data, providing a memory bank for the Business Layer 104 to access as required.

System 100 can also maintain an API. The API can enable customers to ingest data to the platform and retrieve insights and interact with system 100.

System 100 can implement an AI-based orchestration workflow. An example of a scenario is now discussed. System 100 can review a particular vendor configuration are meet the best practices. An adaptive learning system learns the best practices close to real-time. Pre-defined workflows can be run by system 100. Each scenario represents a typical analysis done by a SOC person. It is noted that workflow orchestration has various building blocks that can be put together to run a scenario. For example, system 100 can run a health check on a security vendor configuration and validate that it meets specified best practices.

System 100 can also include an orchestration manager. The orchestration manager can create an orchestration flow on the fly (e.g. using specified auto-workflow creation processes, etc.). These can be based on a dynamic use case.

For example, the adaptive learning system of System 100 can detect a cyber threat from public sources. The dynamic scenario catalog creates new threat scenarios based on the adaptive learning system. The orchestration manager picks up the dynamic-based scenario and checks whether it has all the building blocks to execute that. If so, system 100 builds a dynamic orchestration workflow utilizing AI capabilities. It can provide a recommendation based on the assessment and indication to the Human to interact with (e.g. approve the change or keep it in the visibility mode).

System 100 can implement an auto workflow creation (AWFC). AWFC uses the pre-defined knowledge about the various building blocks in the orchestrator (e.g. a GPT query node, embed search node, prompt node, etc. System 100 can see the sample workflow that a person created using these building blocks. AWFC utilizes this knowledge to generate workflow code just like the way it generates Python code for a scenario. It then creates the flow and tests this flow using the input and expected out. System 100 feeds the input and output to the AWFC again to refine the flow to get to a satisfactory level.

An example sample workflow is now provided. In this simple workflow, system 100 obtains input from another process (e.g. Microsoft configuration best practices validator input) and uses that input data to figure out various helpful information for the SOC operations team such as remediation steps and risks associated with a particular configuration before they implement that. System 100 uses various generative models to obtain possible answers and validate them against each other to improve the quality. Example generative models can include, inter alia, the Generative Pre-trained Transformer (GPT)-n series of large language models.

System 100 can also provide/manage a real-time central policy hub. This can be a central place where the hub has visibility and knowledge about the configurations and policies of various cyber security vendor.

System 100 can provide/manage a contextual system. This can understand customer persona and their activities and risk appetite, sensitivity to productivity, etc. System 100 can understand the vulnerabilities of each asset and risks of users dynamic scenario catalog.

System 100 can handle static scenarios. System 100 can provide a list of health checks which an expert created. This is an assessment item. System 100 can use scenario details to know the objective of the HC and access the memory store to pick more data needed. System 100 can also understand dynamic HCs. System 100 can put this together on the fly based on the event.

System 100 can implement an Adaptive Learning System. The Adaptive Learning System can include and/or interface with Generative AI system that learns about each vendor configuration and its dependencies and implications and potential productivity issues etc. from various knowledge sources. These knowledge sources can include, inter alia: documentation, support systems, public forums, etc. The Adaptive Learning System collects and stores the information into long-term memory like Databases, file storage, Vector databases etc. Information can be collected from Vendor documentation, Public sources, support systems, or threat intelligence sources. Adaptive Learning System include a system with memory to store knowledge. In one example, this can be a vector database. Adaptive Learning System can include a data collection and processing unit as well.

System 100 can implement/include a contextual system. The contextual system can extract the contextual information from the customer environment so that every policy decision can be made with real meaningful context. These can include customer preferences (e.g. risk appetite, Productivity sensitivity, etc.). These can include control systems in place as well. System 100 can provide access to the central policy/configurations hub.

System 100 can provide policy recommendations and human interactions. Recommend policy changes can be based on the scenario that was evaluated as well as various context data and adaptive learning data. It is noted that human users may want to validate the recommendations and approve them. Here humans can provide input to the system so the system can learn about the administrative preferences of potential future actions.

System 100 can implement policy recommendations. Process of Policy recommendations can involve obtaining the output of the HC. System 100 can analyze the output with the customer context (e.g. preference, available security control, risk appetite, vertical risk, Threat risk-vulnerabilities, current threats, current configurations, etc.). System 100 can prioritize the recommendations and show the result in UI for Customer input (e.g. mark it as a valid and plan to take action, etc.).

System 100 can include various sub-systems and methods for cybersecurity management based on contextual adaptive learning can be implemented. System 100 can be configured to provide a sophisticated approach to cybersecurity policy management that leverages contextual adaptive learning to create a more intelligent and responsive security environment. System 100 can be implemented to continuously refine security control settings to align with an organization's specific risk posture and appetite, wherein cybersecurity policies can be automatically adapted based on multiple factors including existing security measures, budgetary constraints, and organizational activities.

The system architecture can be structured into three primary layers that can be implemented to work in concert to deliver comprehensive cybersecurity management. These layers and their components can be described in detail as follows:

Interface Layer 102 implementation is now discussed. The Interface Layer 102 can be implemented to serve as the primary point of contact between the system and its users, wherein three distinct interaction methods can be provided. A UI Portal can be implemented as the primary interface for customers and partners, wherein a sophisticated yet intuitive way to interact with the system can be provided. Through the UI Portal, users can be enabled to view real-time recommendations and policy insights, wherein remediation actions can be directly managed. The UI Portal can be configured to receive valuable feedback that can be utilized to automatically refine and tune the system's recommendations. Additionally, customizable dashboards that can be tailored to different stakeholder needs can be accessed, wherein system settings and preferences can be configured.

An API component can be implemented to enable programmatic interaction with the system. The API can be configured to provide RESTful endpoints for seamless integration, wherein robust authentication mechanisms can be implemented. The API can further be configured to support integration with external tools and systems for seamless automation and data exchange. Sophisticated rate limiting and quota management capabilities can be provided, wherein real-time webhook notifications can be generated. Comprehensive documentation and SDK support can be provided through the API interface.

An AI Chat Bot can be implemented as an advanced interface that leverages Generative AI to provide natural language interaction. The AI Chat Bot can be configured to convert user queries into actionable system commands, wherein detailed analytical reports can be generated. Policy and configuration updates can be executed through the AI Chat Bot, wherein contextual guidance and support can be provided. Complex problem-solving can be facilitated through the management of multi-turn conversations.

Business Layer 104 implementation is now discussed. The Business Layer 104 can be implemented to represent the system's core intelligence, wherein information processing and decision-making can occur. Multiple sophisticated components can be implemented to work together within this layer.

An Exposure Management Recommendations component can be implemented to analyze and manage cybersecurity threats and exposures across multiple dimensions. Security control tool gap identification can be performed, wherein configuration gap detection and assessment can be executed. The component can be configured to support both simple and complex policies, wherein simple policies can include CrowdStrike configurations and complex policies can include Netskope and Mimecast implementations with deep contextual understanding. Policy gap analysis and remediation can be implemented, wherein vulnerability exposure management can be performed. Human behavior pattern analysis can be conducted through this component.

A Security Insights component can be implemented to provide comprehensive visibility into an organization's security posture. Asset monitoring and management can be performed, wherein assets in the organization can include users, devices, applications, and network components. Protection coverage gap analysis can be executed to identify basic protection deficiencies, wherein configuration gap assessment can be conducted for security control configurations. Human risk metrics can be generated, wherein vulnerability prioritization can be implemented through this component.

An Exposure Validation and Prioritization component can be implemented to employ sophisticated algorithms. Security exposures can be validated, wherein issues can be prioritized based on multiple factors including severity, blast radius, alternate security controls, productivity impact, and business context integration. The component can be configured to help SOC teams focus on critical areas, wherein prioritization can be performed based on organizational context.

A Remediation Automation component can be implemented to handle the automated implementation of security fixes. Policy updates can be automated, wherein gradual policy rollout procedures can be executed to ensure minimal disruption. Systematic feedback collection can be implemented, wherein multi-stage approval workflows can be managed. Rollback capabilities can be provided, wherein impact monitoring can be performed.

A Workflow Orchestration and Execution Engine can be implemented to manage the automation and execution of security workflows through several key components. The engine can be configured to translate AI-generated recommendations into actionable, modular workflows that can be visualized, validated, and executed. Human feedback can be incorporated to ensure reliability and eliminate inaccuracies such as those that might arise from LLM-generated recommendations.

The Workflow Orchestration and Execution Engine can include multiple sub-components:

A Workflow Orchestration Server (e.g. Queue Controller) can be implemented to serve as the central controller managing workflow lifecycle. The server can be configured to handle execution queues, wherein workflows can be executed in the correct sequence. Dependencies and conditional logic between workflow nodes can be managed, wherein workflow execution can be dynamically adjusted based on feedback or contextual changes. For example, the server can control the sequence for a Zscaler policy analysis workflow, ensuring data collection nodes execute before rule validation nodes.

A Workflow Execution Engine can be implemented to coordinate the execution of individual nodes and manage their interconnections. The engine can be configured to schedule and trigger node execution based on workflow logic, wherein workflow progress can be tracked and error handling for failed nodes can be ensured. Dynamic updates during execution can be enabled based on intermediate results or feedback. For example, the engine can execute a multi-step workflow to analyze vulnerabilities, validate policies, and recommend mitigations.

A Node Executor can be implemented to execute individual nodes representing discrete business logic tasks within a workflow. Tasks such as data retrieval, analysis, transformation, or validation can be processed, wherein intermediate results can be temporarily stored for use by subsequent nodes. For example, the executor can process a node to fetch asset configuration data, followed by another node to analyze it against security best practices.

Multiple data storage components can be implemented within the Workflow Orchestration and Execution Engine:

A Data Store (e.g. Workflow Details) can be implemented to serve as the permanent storage for all workflows, including their structures, logic, and metadata. Reusable workflows validated by human experts can be stored, wherein a repository for workflow templates and past executions can be provided for auditing and reuse. For example, the Data Store can maintain a Zscaler policy optimization workflow for reuse across similar use cases.

An Intermediate Store (e.g. Execution Metadata) can be implemented to temporarily hold data generated during workflow execution for use by downstream nodes. Intermediate results such as fetched data, calculated values, or transformation outputs can be collected and stored, wherein smooth handoff of data between nodes within a workflow can be ensured. For example, vulnerability scan results that can be later used to prioritize remediation steps can be stored.

A Data Analysis Store (e.g. Execution Results) can be implemented to store the final output of workflow executions for analysis, reporting, and decision-making. A historical record of workflow outcomes can be maintained for review and auditing, wherein results can be provided to other system components such as visualization and remediation engines.

A Data Analyzer Service (e.g. Visualization Enabler) can be implemented to provide visual representation of workflows and their execution results for expert review and feedback. Workflows can be visualized as connected nodes, wherein dependencies, conditions, and results can be highlighted. The service can enable experts to validate, modify, or approve workflows before execution. For example, a workflow map showing steps to analyze and optimize Netskope configurations can be displayed, enabling security experts to add missing conditions.

An Adaptive Learning System and Recommendation Engine can be implemented as the core AI module within the Business Layer. The engine can be configured to power contextual recommendations for cybersecurity management through a combination of dynamic and static contextual data, business priorities, and adaptive learning algorithms. Human and system feedback can be integrated to refine recommendations and continuously improve performance over time.

The Adaptive Learning System and Recommendation Engine can include multiple sophisticated input sources. Rich Context Data can be implemented to process inputs from the Data Collection and Context Extraction system, wherein dynamic context data 139 such as security controls, asset details, incidents, and vulnerabilities can be analyzed. Static knowledge sources including vendor documentation and best practices can be processed to ensure recommendations are contextually relevant to both technical environment and organizational policies. Knowledge data 140 can include, inter alia, vendor product documentation, support documentation, best practices, security framework data, expert knowledge articles, etc.

A Feedback Processing System can be implemented to handle both human feedback and system-level feedback. Human feedback regarding post-change disruptions and impact on employee experience can be processed, wherein system feedback can be analyzed. For example, the system can be configured to determine whether a policy change reduced productivity or if security exposure persisted after remediation.

A Prioritization Input component can be implemented to synthesize business factors and security considerations. Organizational priorities and productivity impact can be evaluated, wherein severity and alternative controls can be assessed. For example, the component can be configured to determine if vulnerabilities in high-priority applications should be addressed before lower-priority issues.

A Business Logic Layer can be implemented within the engine to process business use cases by integrating context, feedback, and prioritization data. The layer can generate tailored recommendations through multiple key features.

A Recommendation Generation component can be implemented to combine vendor recommendations, licensing details, alternate security measures, and feedback to provide actionable insights. For example, the system can be configured to suggest improvements to CrowdStrike configurations while considering existing protections from Zscaler and employee experience scores. Dynamic Adaptation capabilities can be implemented to continuously adapt recommendations based on evolving contexts and feedback loops.

A Knowledge Base can be implemented to store extracted knowledge in structured formats. A Rule Repository can be configured to house cybersecurity best practices, configuration standards, and contextual rules, wherein Vectorized Data capabilities can enable efficient retrieval and advanced AI-driven analysis.

An LLM Core component can be implemented with multiple specialized elements:

A Security Fine-Tuned LLM can be implemented as a specialized large language model trained on cybersecurity use cases. The model can be configured to power natural language interaction and context-based recommendation generation.

A Prompt Library can be implemented to maintain a curated collection of predefined prompts. The library can be configured to guide the LLM in specific tasks, such as analyzing Zscaler policies or recommending policy updates.

AI Agents 176 can be implemented as modular AI components capable of performing specific tasks. For example, an AI agent can be configured to compare a Zscaler policy with best practices and suggest optimizations, wherein policy validation and workflow execution can be performed.

A Workflow Engine can be implemented to automate business logic execution through dynamically generated workflows. The engine can be configured to create modular workflows based on use cases, wherein each block can connect to others to perform end-to-end tasks. For example, a workflow for Zscaler ZIA policy analysis can be configured to include steps to fetch data, validate configurations, and recommend changes.

The Workflow Engine can implement Dynamic Adaptation capabilities to adapt workflows based on business priorities and contextual changes. Output Options can be configured to enable workflows to generate new workflows or direct recommendations, wherein recursive automation can be enabled. For example, the engine can be configured to automatically mitigate Zscaler policy misconfigurations by generating a remediation workflow.

A Data Collection and Context Extraction system can be implemented as a critical component that processes raw data into structured, contextualized information. The system can be configured to enable both dynamic and static contexts to be utilized for cybersecurity insights, recommendations, and automation workflows. Three primary sub-components can be implemented within this system:

A Data Ingestion component can be implemented to serve as the entry point for all data sources, wherein both structured and unstructured data from diverse systems can be processed. The component can be configured to clean, validate, and normalize incoming data to ensure consistency. Data tokenization and formatting into structured representations for downstream processing can be performed. The component can be configured to process various input types, including asset inventories comprising devices, users, and applications, wherein configuration data, activity logs, threat intelligence, and vendor documentation can be processed. The outcome can ensure that all input data is pre-processed and ready for Context generation.

An NLP Context Extraction component can be implemented to leverage Natural Language Processing to extract deeper context from unstructured or semi-structured text sources. Named Entity Recognition (NER) capabilities can be implemented to identify key entities such as device names, users, vulnerabilities, or configurations from unstructured text. Entity Relationship Extraction can be performed to map relationships between identified entities. For example, the system can be configured to extract from a document that “Device X is vulnerable to CVE-2024-12345” and link it to the configuration details of “Policy Y.” The component can be further configured to summarize and structure data from textual inputs such as vendor documentation and threat reports.

A Contextualization component can be implemented to transform ingested data into meaningful, actionable contexts. Static Context Generation capabilities can be implemented to convert static knowledge, such as best practices and security framework rules, into structured formats like rules or vector embeddings for easy retrieval and application. For example, a “best practice rule for device configurations” can be stored as a queryable vector. Dynamic Context Mapping can be implemented to establish dynamic relationships between entities, including device-to-user, device-to-vulnerability, and policy-to-configuration mappings.

The Memory and AI Layer 106 can be implemented to provide persistent storage and retrieval capabilities through multiple specialized components:

A Vector DB can be implemented to store knowledge in a vectorized format for efficient retrieval. The database can be configured to power advanced search and AI query processing capabilities, wherein semantic indexing and pattern recognition support can be provided. The Vector DB can enable efficient similarity search operations for complex query processing.

A Large Language Model (LLM) component can be implemented as a central AI model enabling adaptive learning, recommendations, and natural language interaction. The model can be configured to enhance the system's contextual understanding and decision-making capabilities. Natural language processing functionalities can be implemented, wherein context interpretation and response generation can be performed.

A Relational Database can be implemented to store structured data such as configurations, controls, assets, and activity logs. The database can be configured to provide structured data management capabilities, wherein configuration storage and control data maintenance can be performed. Relationship mapping functionalities can be implemented to maintain connections between different data entities.

A File Storage system can be implemented to house unstructured and semi-structured data. The system can be configured to store customer-provided files, vendor documentation, and static data uploads. Document management capabilities can be implemented, wherein binary file handling and archive management can be performed.

Example Business Use Cases of the system can include, inter alia:

A Zscaler ZIA Policy Optimization implementation can be configured to analyze current policies and recommend updates to improve security posture without affecting productivity. The system can be configured to analyze existing Zscaler configurations, wherein recommendations for optimizations can be generated based on security best practices and organizational requirements.

A CrowdStrike Configuration Enhancement implementation can be configured to identify gaps in endpoint protection and suggest configurations based on vendor best practices. The system can analyze current endpoint security configurations, wherein recommendations for improved security settings can be generated.

A Zero Trust Architecture Improvement implementation can be configured to evaluate current implementation against best practices and recommend enhancements to strengthen access control. The system can analyze existing zero trust configurations, wherein recommendations for strengthening security measures can be generated.

The system can be configured to generate multiple types of outputs and deliverables to support comprehensive cybersecurity management. Actionable Recommendations can be implemented to provide tailored insights for policy updates, configuration adjustments, or remediation actions. These recommendations can be generated based on the deep contextual understanding of the organization's security posture and operational requirements. For example, when a security configuration gap is identified in a Zscaler implementation, the system can generate specific, contextually-aware recommendations that consider existing security controls and organizational impact.

Automated Workflows can be implemented to generate or execute processes for immediate remediation or further analysis. These workflows can be configured to operate with varying levels of automation, wherein human validation can be incorporated at critical decision points. For instance, when a critical vulnerability is identified in a CrowdStrike endpoint configuration, an automated workflow can be generated to implement the necessary security controls while ensuring appropriate approvals are obtained.

The system can implement several key advantages that enhance its operational effectiveness. Context-Aware Decision-Making can be implemented through the integration of rich contextual data to generate informed recommendations. The system can be configured to consider multiple contextual factors simultaneously, wherein security requirements, operational impact, and organizational priorities can be balanced. For example, when analyzing a proposed security policy change, the system can evaluate its impact across various dimensions including user productivity, existing security controls, and compliance requirements.

Scalable Automation capabilities can be implemented through dynamically generated workflows and modular AI agents 176. The system can be configured to enable efficient scaling across diverse use cases, wherein complexity can be managed through modular components. For example, a workflow created for analyzing Zscaler policies can be automatically adapted for use with other security tools, maintaining consistency while accounting for tool-specific requirements.

Continuous Learning mechanisms can be implemented to ensure recommendations improve over time. Feedback loops can be configured to adapt to evolving business and security needs, wherein both explicit and implicit feedback can be incorporated. For instance, when a recommendation is implemented, the system can monitor its effectiveness and user impact, automatically adjusting future recommendations based on observed outcomes.

Integration capabilities can be implemented to enable seamless interaction with existing security infrastructure. The system can be configured to integrate with various security tools and platforms through standardized APIs and custom connectors. For example, integration with Zscaler, CrowdStrike, Netskope, and Mimecast can be implemented to enable comprehensive security policy management across the security stack.

Cross-vendor mesh capabilities can be implemented to enable coordinated security responses across multiple tools. The system can be configured to understand the relationships and dependencies between different security tools, wherein coordinated policy updates can be implemented. For instance, when a security policy is updated in Zscaler, the system can automatically evaluate and recommend corresponding updates in related security tools to maintain consistent security coverage.

Implementation considerations can be provided to ensure optimal system deployment and operation. The system can be configured to support progressive deployment models, wherein functionality can be gradually expanded based on organizational readiness and requirements. For example, implementation can begin with basic policy analysis capabilities and progressively expand to include advanced automation and cross-tool coordination.

Quality assurance mechanisms can be implemented throughout the system to ensure reliable operation. Validation checks can be configured at multiple levels, wherein both automated and human-guided validation can be performed. For example, before implementing a security policy change, the system can perform automated impact analysis and present the results for expert review.

The system can implement comprehensive audit and compliance capabilities. Detailed logging and tracking mechanisms can be configured to maintain records of all system actions and decisions, wherein compliance with regulatory requirements can be demonstrated. For instance, all policy changes and their justifications can be automatically documented and preserved for audit purposes.

Security and access control mechanisms can be implemented to ensure appropriate system usage. Role-based access control can be configured to manage system access and capabilities, wherein different user roles can be assigned appropriate permissions. For example, while SOC analysts might have access to view recommendations, approval for implementation might be restricted to senior security personnel.

Through this comprehensive implementation approach, the system can provide organizations with sophisticated, context-aware cybersecurity management capabilities that continuously adapt to evolving security requirements while maintaining operational efficiency and regulatory compliance.

Another embodiment of system 100 is now discussed. Interface Layer 102 can include a UI Portal 108 that serves as the primary human interface, creating an intuitive environment where customers and partners can directly engage with the system's capabilities. UI Portal 108 can include a sophisticated dashboard where users can not only view critical information like recommendations and policy insights but also take active control of security management through remediation actions. UI Portal 108 can include a feedback integration system; as users interact with the recommendations and provide their input, the system automatically refines and tunes its future recommendations, creating a continuously improving cycle of security management.

Working alongside the UI Portal 108, the API 110 component extends the system's reach by enabling programmatic interaction. This means organizations can seamlessly integrate the system's capabilities into their existing security infrastructure and workflows. The API 110's support for external tools and systems creates an automation framework that allows security operations to function more efficiently, reducing manual intervention while maintaining robust security controls.

The third component, the AI Chat Bot 112 introduces a natural language interface powered by Generative AI technology. AI Chat Bot 112 creates a more accessible way for users to interact with complex security systems; instead of needing to understand specific technical commands, users can express their needs in everyday language. AI Chat Bot 112 includes translation capabilities convert these natural language queries into precise system commands and workflows, enabling users to generate reports, conduct analyses, or update policies and configurations through conversational interaction. Thus, system 100 provides capabilities more accessible to users with varying levels of technical expertise. Together, these three components create a layered approach to system interaction, ensuring that users can engage with the security management system in whatever way best suits their needs and technical capabilities.

Business Logic Layer 104 can implement an Exposure Management Recommendations component 114 that can be implemented to generate recommendations for managing cybersecurity threats and exposures. Exposure Management Recommendations component 114 can be configured to analyze multiple exposure areas, wherein such areas can include Security Control tool gaps comprising Protection Coverage Gaps, Security Control configuration gaps, Policy Gaps, Vulnerability exposures, and Human behavior gaps. Exposure Management Recommendations component 114 can be further configured to support both simple and complex policies, wherein simple policies can include CrowdStrike configurations and complex policies can include Netskope and Mimecast implementations with deep contextual understanding.

A Security Insights component 138 can be implemented to provide comprehensive visibility into security posture for stakeholders. Security Insights component 138 can be configured to generate insights regarding multiple aspects of organizational security, wherein such aspects can include Assets in the Organization comprising users, Devices, Applications, and network components. The insights can further include Security Protection Coverage gaps identifying basic protection deficiencies, Control Configuration gaps related to Security Control configurations, Human risk metrics, and Prioritization of vulnerabilities or issues.

An Exposure Validation and Prioritization component 116 can be implemented to validate identified exposures and prioritize them based on contextual factors. Such factors can include severity assessment, blast radius evaluation, alternate Security controls analysis, Productivity impact, and overall system impact. Exposure Validation and Prioritization component 116 can be configured to assist SOC teams in focusing on critical areas through contextual prioritization.

A Remediation Automation component 118 can be implemented to automate the process of updating and fixing policies. Remediation Automation component 118 can be configured to execute workflows for gradual policy rollout, wherein feedback collection mechanisms and approval processes can be implemented to ensure minimal operational disruption.

A Workflow Orchestration and Execution Engine 120 can be implemented to automate business logic through modular workflows. Workflow Orchestration and Execution Engine 120 can be configured to dynamically generate workflows based on specific use cases and context, wherein such use cases can include Zscaler ZIA policy analysis. Workflow Orchestration and Execution Engine 120 can be further configured to generate outputs comprising actionable recommendations or follow-up workflows.

An Adaptive Learning System and Recommendation Engine 122 can be implemented as a core AI module that utilizes both dynamic and static context to generate recommendations. Adaptive Learning System and Recommendation Engine 122 can be configured to consider multiple factors in generating recommendations, wherein such factors can include vendor and licensing specifics, customer feedback, alternate protection measures, and assessments of severity, friction, and blast radius.

A Central Policy Hub 126 can be implemented as a centralized repository for managing security policies across multiple vendors and tools. Central Policy Hub 126 can be configured to enable policy updates, generate recommendations, and facilitate cross-vendor mesh use cases for comprehensive security management.

A Prioritization Engine 128 can be implemented to rank exposures, policies, and incidents based on organizational priorities. Prioritization Engine 128 can be configured to consider multiple inputs including customer feedback, importance metrics, alternate security controls, and severity assessments to generate tailored prioritization recommendations.

A Data Collection and Context Extraction component 124 can be implemented to collect data through API integration and manual uploads. Data Collection and Context Extraction component 124 can be configured to process Dynamic Context Data 139, wherein such data can include controls and configuration details, asset data comprising devices, users, applications, and networks, activity data including tickets, threats, and incidents, exposures and vulnerabilities, and threat intelligence. Data Collection and Context Extraction component 124 can be further configured to process Static Data and such data can include vendor documentation, best practices and Security Frameworks such as NIST, MITRE, and CIS, and support documentation.

The Memory and AI Layer 106 can include a Vector Database (Vector DB) 130 that can be configured to store knowledge in a vectorized format, enabling efficient information retrieval operations. The Vector DB 130 can support advanced search capabilities and AI query processing functions, facilitating rapid access to relevant security information and contextual data.

A Large Language Model (LLM) 132 component can be implemented as a central AI processing unit that enables adaptive learning capabilities, generates security recommendations, and facilitates natural language interaction with users. The LLM 132 can enhance the system's contextual understanding of security scenarios and support automated decision-making processes based on analyzed security data.

A Relational Database 134 can be implemented to maintain structured data storage for system operations. Relational Database 134 can manage various data types including security configurations, control settings, asset information, and activity logs. This structured storage system can enable efficient data organization and retrieval for security operations.

A File Storage system 136 can be implemented to manage unstructured and semi-structured data assets. The system can store and organize various data types including customer-provided files, vendor documentation, and static data uploads. This storage component can support the system's need to maintain and access diverse forms of security-related documentation and data.

FIG. 1B illustrates an example Adaptive Learning System and Recommendation Engine 122, according to some embodiments. As noted supra, an Adaptive Learning System and Recommendation Engine 122 can be implemented as a core AI module that utilizes both dynamic and static context to generate recommendations. Adaptive Learning System and Recommendation Engine 122 can automate business logic through modular workflows. Adaptive Learning System and Recommendation Engine 122 can dynamically generate workflows based on use cases and context and output actionable recommendations or follow-up workflows. Adaptive Learning and Recommendation Engine 122 serves as the core AI module within the Business Layer, powering contextual recommendations for cybersecurity management. Adaptive Learning and Recommendation Engine 122 system combines dynamic and static contextual data, business priorities, and adaptive learning algorithms to create actionable recommendations. Adaptive Learning and Recommendation Engine 122 can incorporate both human and system feedback to refine recommendations and continuously improve performance over time.

An example Adaptive Learning and Recommendation Engine 122 is now discussed in greater detail. Input Sources (e.g. business use cases, feedback, rich contexts, prioritization input, etc.) can be as follows. A Rich Context Data system receives inputs from the Data Collection and Context Extraction system. These inputs include dynamic context data 139 such as security controls, asset details, incidents, and vulnerabilities, as well as static knowledge sources like vendor documentation and best practices. This comprehensive data collection ensures that recommendations are contextually relevant to both the technical environment and organizational policies.

The Feedback system encompasses both human feedback, such as post-change disruptions and impact on employee experience, and system-level feedback. For example, feedback might indicate whether a policy change reduced productivity or if security exposure persisted after remediation.

The Prioritization Input system synthesizes business factors, such as organizational priorities and productivity impact, along with security considerations like severity and alternative controls. For example, this system determines if vulnerabilities in high-priority applications should be addressed before lower-priority issues.

Business Logic Layer 142 is now discussed. The Business Logic Layer 142 processes business use cases by integrating context, feedback, and prioritization to generate tailored recommendations. Policy and Workflow Recommendation Generation 144 provides capability combines vendor recommendations, licensing details, alternate security measures, and feedback to provide actionable insights. For example, Policy and Workflow Recommendation Generation 144 can suggest improvements to CrowdStrike configurations while considering existing protections from Zscaler and employee experience scores. The Business Logic Layer 142 dynamic adaptation feature continuously adjusts recommendations based on evolving contexts and feedback loops.

Knowledge Base 146 is now discussed. Knowledge Base 146 stores extracted knowledge in structured formats, such as rules and vector embeddings. Knowledge Base 146 rule repository houses cybersecurity best practices, configuration standards, and contextual rules. The system also maintains vectorized data to enable efficient retrieval and advanced AI-driven analysis.

LLM Core 148 is now discussed. Security Fine-Tuned LLM 150 consists of a specialized large language model trained on cybersecurity use cases. Security Fine-Tuned LLM 150 provides a model that powers natural language interaction and context-based recommendation generation.

Prompt Library 152 contains a curated collection of predefined prompts that guide the LLM in specific tasks, such as analyzing Zscaler policies or recommending policy updates.

The AI Agents 176 are modular AI 154 components capable of performing specific tasks, such as validating policies and executing workflows. For example, an AI agent might compare a Zscaler policy with best practices and suggest optimizations.

FIG. 1C illustrates an example Data Collection and Context Extraction 124, according to some embodiments. The Data Collection and Context Extraction 124 is a critical component that processes raw data into structured, contextualized information. Data Collection and Context Extraction 124 enables dynamic and static contexts to be utilized for cybersecurity insights, recommendations, and automation workflows. Data Collection and Context Extraction 124 consists of three primary sub-components.

Data Ingestion 160 acts as the entry point for all data sources, processing both structured and unstructured data from diverse systems. Data Ingestion 160 cleans, validates, and normalizes incoming data to ensure consistency. Data Ingestion 160 tokenizes or formats data into structured representations for downstream processing. Examples of Inputs can include, inter alia: asset inventories (e.g., devices, users, applications); configuration data, activity logs, threat intelligence, and vendor documentation. Data Ingestion 160 can ensures that all input data is pre-processed and ready for Context generation.

NLP Context Extraction 158 leverages Natural Language Processing (NLP) to extract deeper context from unstructured or semi-structured text sources. NLP Context Extraction 158 can implement Named Entity Recognition (NER). Here, it identifies key entities like device names, users, vulnerabilities, or configurations from unstructured text. NLP Context Extraction 158 can perform entity Relationship Extraction. NLP Context Extraction 158 can maps relationships between identified entities. NLP Context Extraction 158 extracts from a document that “Device X is vulnerable to CVE-2024-12345” and links it to the configuration details of “Policy Y.” NLP Context Extraction 158 summarizes and structures data from textual inputs (e.g., vendor documentation, threat reports). NLP Context Extraction 158 converts unstructured inputs into actionable insights that enrich the contextualization process.

Contextualization module 156 is now discussed. Contextualization module 156 can transform ingested data into meaningful, actionable contexts. Contextualization module 156 perform Static Context Generation. Contextualization module 156 converts static knowledge (e.g. best practices, security framework rules) into structured formats like rules or vector embeddings for easy retrieval and application. For example: “Best practice rule for device configurations” is stored as a queryable vector. Contextualization module 156 can perform Dynamic Context Mapping. Here, Contextualization module 156 can establish dynamic relationships between entities (e.g. device-to-user, device-to-vulnerability, policy-to-configuration). For example, Contextualization module 156 can map a device's security vulnerabilities to its associated user and active policies to identify gaps. This provides a foundation for decision-making, ensuring recommendations and actions are contextually grounded. The output of 124 can include, inter alia: Structured Data (e.g. clean, enriched, and contextualized data for use in workflows, recommendations, or automation tasks); Dynamic Maps (e.g. relationship maps showing dependencies among assets, policies, users, and vulnerabilities); and/or Knowledge Artifacts (e.g. static rules and vector embeddings that can be queried by other system components).

FIG. 1D illustrates an example Workflow Orchestration and Execution Engine 120, according to some embodiments. Workflow Orchestration and Execution Engine 120 is a system designed to translate AI-generated recommendations into actionable, modular workflows. These workflows are visualized, validated, and executed with the goal of automating business logic and solving complex cybersecurity problems. By incorporating human feedback, the system ensures reliability and eliminates inaccuracies, such as hallucinations from LLM-generated recommendations.

Workflow Orchestration Server 168 (e.g. includes a Queue Controller) can serves as the central controller that manages the lifecycle of workflows, including queueing, prioritizing, and orchestrating their execution. Workflow Orchestration Server 168 can handles execution queues, ensuring that workflows are executed in the correct sequence. Workflow Orchestration Server 168 can manage dependencies and conditional logic between workflow nodes. Workflow Orchestration Server 168 can dynamically adjust workflow execution based on feedback or contextual changes. Workflow Orchestration Server 168 can control the sequence for a Zscaler policy analysis workflow, ensuring data collection nodes run before rule validation nodes.

Workflow Execution Engine 166 executes workflows by coordinating the execution of individual nodes and managing their interconnections. Workflow Execution Engine 166 schedules and triggers node execution based on workflow logic. Workflow Execution Engine 166 tracks workflow progress and ensures error handling for failed nodes. Workflow Execution Engine 166 enables dynamic updates during execution based on intermediate results or feedback. Workflow Execution Engine 166 executes a multi-step workflow to analyze vulnerabilities, validate policies, and recommend mitigations.

Node Executor 164 executes individual nodes, which represent discrete business logic tasks within a workflow. Node Executor 164 processes tasks such as data retrieval, analysis, transformation, or validation. Node Executor 164 temporarily stores intermediate results for use by subsequent nodes. Node Executor 164 executes a node to fetch asset configuration data, followed by another node to analyze it against security best practices.

Data Store 172 (e.g. includes Workflow Details) serves as the permanent storage for all workflows, including their structures, logic, and metadata. Data Store 172 stores reusable workflows validated by human experts. Data Store 172 provides a repository for workflow templates and past executions for auditing and reuse. Data Store 172 stores a Zscaler policy optimization workflow for reuse across similar use cases.

Intermediate Store 170 (e.g. Execution Metadata) temporarily holds data generated during workflow execution for use by downstream nodes. Intermediate Store 170 collects and stores intermediate results such as fetched data, calculated values, or transformation outputs. Intermediate Store 170 ensures smooth handoff of data between nodes within a workflow. Intermediate Store 170 stores vulnerability scan results that are later used to prioritize remediation steps.

Data Analysis Store 168 (e.g. includes Execution Results) stores the final output of workflow executions for analysis, reporting, and decision-making. Data Analysis Store 168 maintains a historical record of workflow outcomes for review and auditing. Data Analysis Store 168 provides results to other system components (e.g., visualization, remediation engines). Data Analysis Store 168 stores the output of a workflow that recommends policy updates for high-risk applications.

Data Analyzer Service 162 (e.g. includes Visualization Enabler) provides a visual representation of workflows and their execution results for expert review and feedback. Data Analyzer Service 162 visualizes workflows as connected nodes, highlighting dependencies, conditions, and results. Data Analyzer Service 162 allows experts to validate, modify, or approve workflows before execution. Data Analyzer Service 162 displays a workflow map showing the steps to analyze and optimize Netskope configurations, enabling a security expert to add missing conditions.

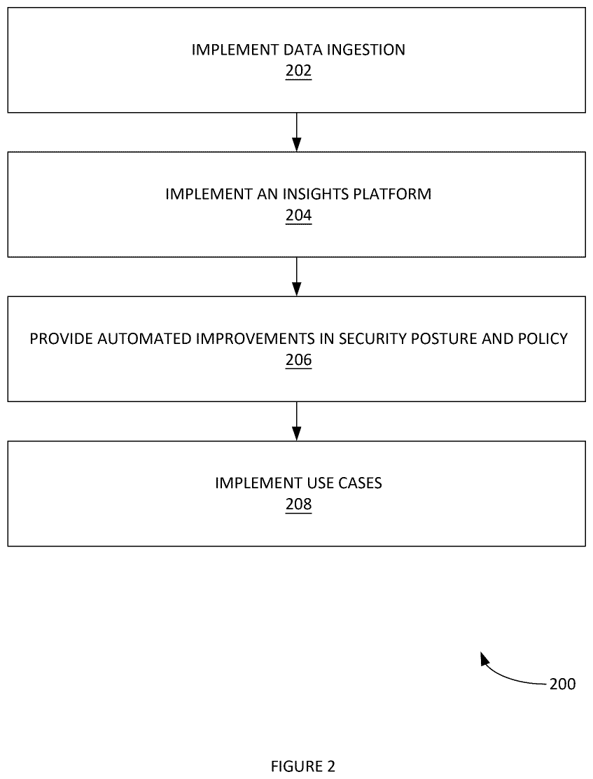

FIG. 2 is an example process 200 for dynamic cybersecurity policy management based on contextual adaptive learning, according to some embodiments. Process 200 can implement a dynamic, context-aware policy management system through adaptive learning powered by AI technologies. Process 200 acquires knowledge on diverse aspects of the clients, such as business specifics, risk tolerance, existing cybersecurity measures, and their comprehensiveness and settings. Process 200 then assists clients in advancing their security stance by harmonizing productivity and security.

More specifically, in step 202, process 200 implements data ingestion. Here, process 200 can import large, assorted data files from multiple sources into a single, cloud-based storage medium—a data warehouse, data mart or database—where it can be accessed and analyzed. This can include data ingestion across endpoint, email, web, cloud, calendar, productivity applications. Process 200 can also leverage APIs and extensions to collect the telemetry for the top cybersecurity platforms.

In step 204, process 200 implements an insights platform. This can be a first phase of dynamic cybersecurity policy management based on contextual adaptive learning method on the ingested data. Process 200 can generate curated/targeted insights as a service. This can be shared by the CISO with various stakeholders. Process 200 can deliver insights (e.g. and not data lakes, etc.). Process 200 utilize, inter alia: an insights engine, a next generation visualization platform, and cross platform intelligence to implement step 204.

In step 206, process 200 can implement an actions platform. Here, process 200 can implement a policy/configurations. Process 200 can utilize an automation workflow. Process 200 can provide management outcomes measurement(s) as well. Process 200 can provide automated improvements in security posture and policy as well in step 206.

In step 208, process 200 can implement use cases. Process 200 can change policies automatically.

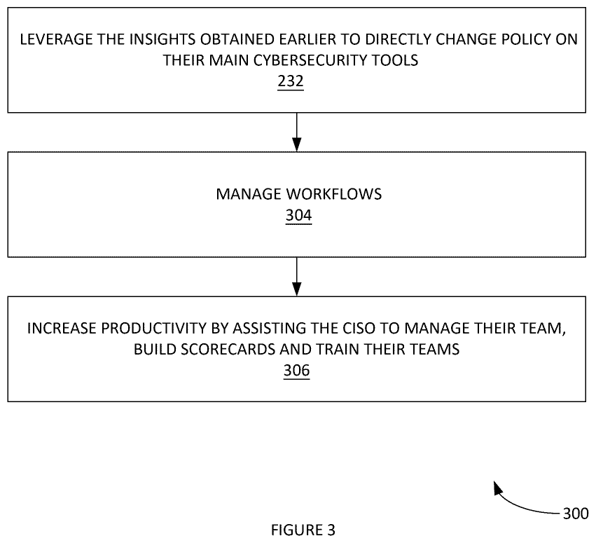

FIG. 3 illustrates an example process 300 for implementing use cases in a dynamic cybersecurity policy management context, according to some embodiments. Process 300 can be used to implement step 208. In step 302, process 300 can leverage the insights obtained earlier to directly change policy on their main cybersecurity tools.

In step 304, process 300 can manage workflows. When a policy cannot be changed, start the right workflows integrating with the appropriate system (e.g. Slack, Teams, SOAR and ServiceNow, by way of example). In step 306, process 300 can increase productivity by assisting the CISO to manage their team, build scorecards and train their teams.

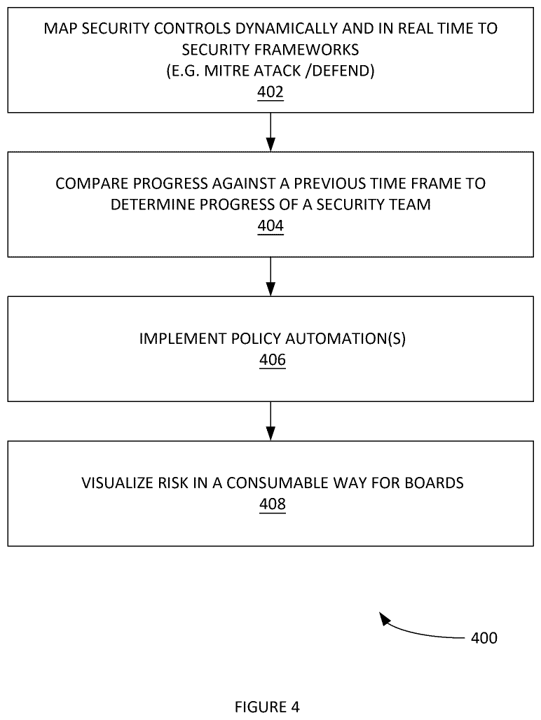

FIG. 4 illustrates another example process 400, according to some embodiments. In step 402, process 400 map security controls dynamically and in real time to security frameworks (e.g. MITRE attack/defend).

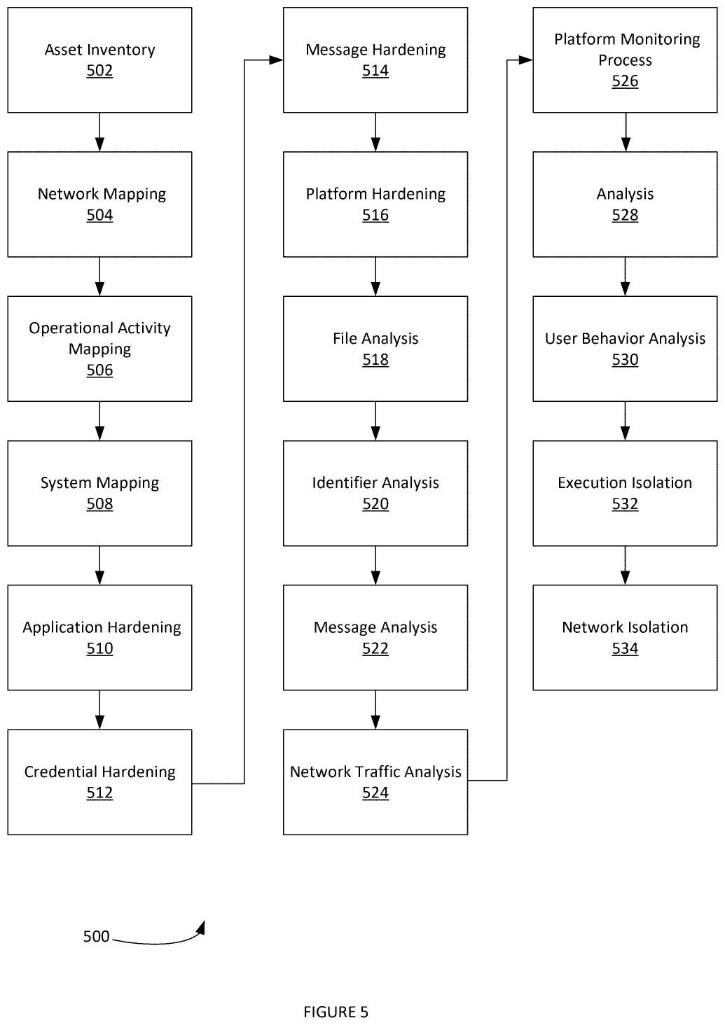

In step 404, process 300 compares progress against a previous time frame to determine progress of a security team. By way of example FIG. 5 illustrates an example of comparing progress to three months previously (e.g. as shown schematically with white space) to show the progress of an example security team.

More specifically FIG. 5 illustrates an example process flow for a MITRE D3FEND framework, according to some embodiments.

In step 502, process 500 implements an Asset Inventory Process Flow. Step 502 can include, inter alia: a) Asset Vulnerability Enumeration b) Configuration Inventory c) Hardware Component Inventory d) Network Node Inventory e) Software Inventory; etc.

In step 504, process 500 implements an Network Mapping Process Flow. This can include, inter alia: a) Logical Link Mapping; b) Network Traffic Mapping; c) Physical Link Mapping; etc.

In step 506, process 500 implements an Operational Activity Mapping Process Flow. Step 506 can include, inter alia: a) Access Modeling; b) Privileged Permission Mapping; c) Network Traffic Pattern Analysis; d) Operation Mapping; etc.

In step 508, process 500 implements a System Mapping Process Flow. Step 508 can include: a) Data Exchange Mapping; b) Interflow Communication Mapping; c) Intraflow Communication Mapping; d) Process Lineage Mapping; etc.

In step 510, process 500 implements an Application Hardening Process Flow. Step 510 can include: a) Application Configuration Hardening; b) Application Code Obfuscation; c) Application Isolation; d) Software Update; etc.

In step 512, process 500 implements a Credential Hardening Process Flow. In step 512, process 500 can perform, inter alia: a) Biometric Authentication; b) Credential Transmission Scoping; c) Hardware-Supported Credential Storage; d) Multi-Factor Authentication; e) Password Hardening; f) Single Sign-On Provision; g) Strong Password Policy; h) User Account Permissions; etc.

In step 514, process 500 implements a Message Hardening Process Flow. Step 514 can include, inter alia: a) Message Authentication; b) Message Encryption; c) Remote Data Storage; etc.

In step 516, process 500 implements a Platform Hardening Process Flow. Step 516 can perform, inter alia: a) Bootloader Authentication; b) Disk Encryption; c) Encrypted Swap File; d) File Permissions; e) Local File Permissions; f) RF Shielding; g) System Configuration Permissions; h) TPM Boot Integrity; etc.

In step 518, process 500 implements a File Analysis Process Flow. Step 518 can implement, inter alia: a) Dynamic Analysis; b) Emulated File Analysis; c) Executable Allowlisting; d) Executable Denylisting; e) File Hashing; f) Static Analysis; etc.

In step 520, process 500 implements an Identifier Analysis Process. Step 520 can perform, inter alia: a) Homoglyph Detection; b) Identifier Encoding Analysis; c) Identifier Validity Check; d) Name Resolution Analysis; e) URI Analysis; etc.

In step 522, process 500 implements a Message Analysis Process Flow. Step 522 can perform, inter alia: a) Sender MTA Reputation Analysis; b) Sender Reputation Analysis; c) Software Vulnerability Detection; etc.

In step 524, process 500 implements a Network Traffic Analysis Process Flow. Step 524 can perform inter alia: a) Administrative Network Activity Analysis; b) Certificate Analysis; c) Connection Attempt Analysis; d) Inbound Traffic Filtering; e) Network Traffic Community Deviation; f) Outbound Traffic Filtering; g) Protocol Metadata Anomaly Detection; h) Relay Pattern Analysis; i) Remote Terminal Session Detection; j) RFC Specification Compliance Validation; etc.

In step 526, process 500 implements a Platform Monitoring Process Flow. Step 526 can perform, inter alia: a) Firmware Behavior Analysis; b) Firmware Embedded Certificates; c) Firmware Verification; d) Host-Local Event Correlation; e) Process Lineage Analysis; f) Process Spawn Analysis; g) System Call Analysis; h) System File Analysis; i) User Data Transfer Analysis; etc.

In step 528, process 500 implements a Process Analysis Process Flow. Step 528 can perform, inter alia: a) Authentication Event Thresholding; b) File Access Pattern Analysis; c) Local Account Monitoring; d) Process Self-Modification Detection; e) Resource Access Pattern Analysis; f) System Call Analysis; g) User Data Transfer Analysis; etc.

In step 530, process 500 implements a User Behavior Analysis Process Flow. Step 530 can perform, inter alia: a) Authentication Event Thresholding; b) Domain Account Monitoring; c) Keylogging; d) Local Account Monitoring; e) Resource Access Pattern Analysis; f) Session Duration Analysis; g) User Data Transfer Analysis; h) User Geolocation Logon Pattern Analysis; etc.

In step 532, process 500 implements an Execution Isolation Process Flow. Step 532 can perform, inter alia: a) Executable Allowlisting; b) Executable Denylisting; c) Hardware-Based Process Isolation; d) Mandatory Access Control; e) Memory Boundary; f) Network Isolation; g) Permission-Based Access Control; h) Process Segment Execution Prevention; i) Segmented Network; j) Virtual Sandbox; etc.

In step 534, process 500 implements a Network Isolation Process Flow. Step 534 can perform, inter alia: a) Broadcast Domain Isolation; b) DNS Denylisting; c) DNS Allowlisting; d) Domain Account Restriction; e) Inbound Traffic Filtering; f) Network Boundary Filtering; g) Network Traffic Filtering; h) Outbound Traffic Filtering; i) Secured Physical Ports; etc. Process 500 provides a comprehensive overview of defensive cybersecurity measures.

Returning to process 400, in step 406, process 400 can implement policy automation(s). By way of example, in the use case of web security an unauthorized P2P SW can be detected by Zscaler. Here, process 400 can automatically tighten CrowdStrike policy for that user's device to block P2P SW. Process 400 can automatically close the loop with user too. This can lead to time saving for SOC.

By way of example, in the use case of Data Leakage an unauthorized public cloud back up detected. Here, process 400 can automatically blacklist use of that public cloud for that user via CASB (e.g. MCAS, Netskope etc.). This can lead to reduced data leakage.

By way of example, in the use case of Email Security. Process 400 can detect multiple spear phishing attempts on high value email ID detected by MS. Here, process 400 can tighten the endpoint sensitivity level for that user's device. Process 400 can leverage MS to trigger a password change/MFA request. This can trigger a phishing simulation test Enhanced policies for high value targets.

By way of example, in the use case of Identity issues. Process 400 can detect multiple credential compromise detections by CrowdStrike. Here, process 400 can automatically change AAD setting for user till they update password and MFA. This can lead to a reduction in compromised credentials detections.

By way of example, in the use case of endpoint detection of removable media (e.g. by Sentinel One, etc.). Process 400 can automatically block specific types of removable media via policy. This can lead to a reduction in ransomware detections.

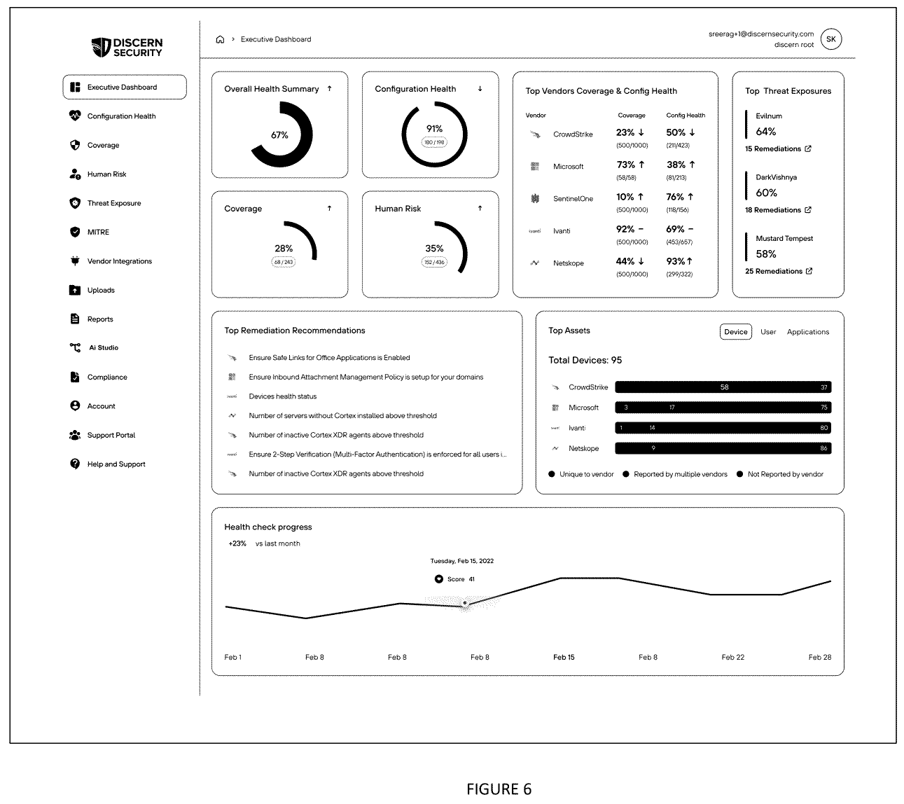

In step 408, process 400 can visualize risk in a consumable way for boards. FIG. 6 illustrates an example set of screenshots 600 for visualizing risk in a consumable way for boards, according to some embodiments.

FIG. 6 illustrates an example screenshot of an Executive Dashboard, according to some embodiments. FIG. 6 illustrates a summary of all features for Executive conception.

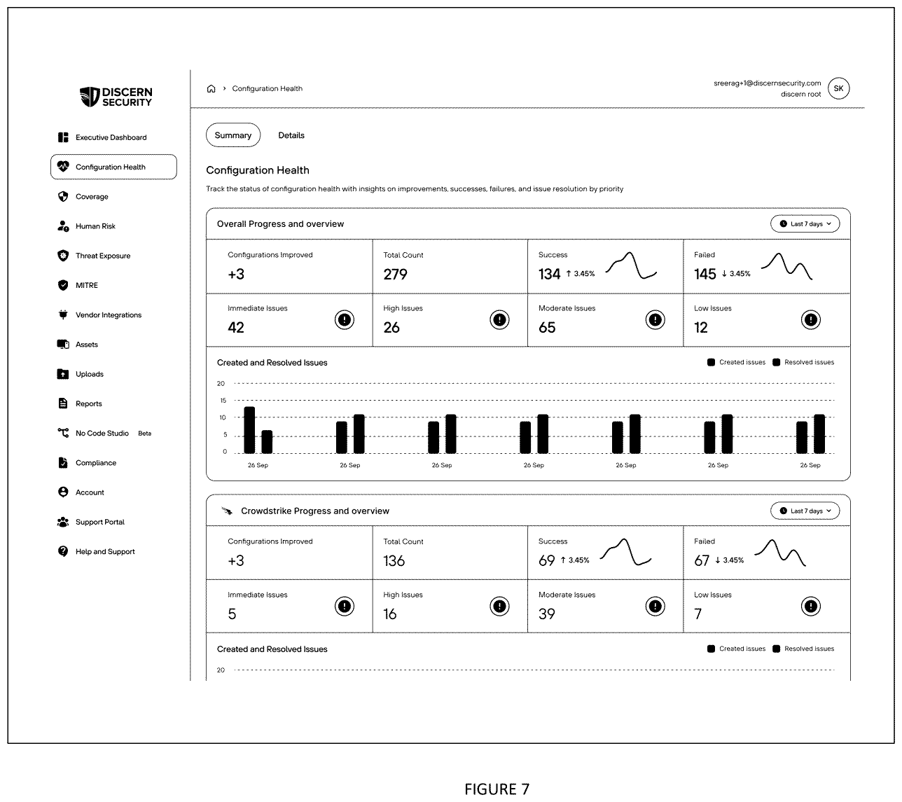

FIG. 7 illustrates an example screenshot of Configuration Health Summary, according to some embodiments. FIG. 7 illustrates a summary of each security Vendor configuration gaps against best practices.

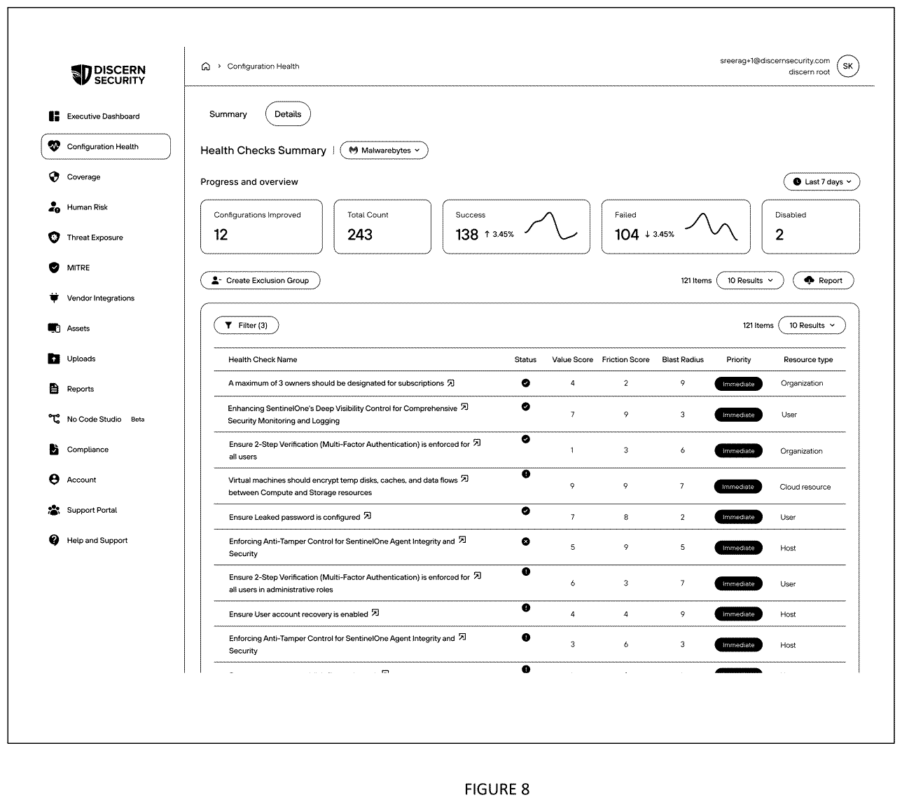

FIG. 8 illustrates an example screenshot of Configuration Health Details, according to some embodiments. FIG. 8 provides a summary of each security Vendor configuration gaps against best practices. This has knowledge details for taking remediation action and automation workflow.

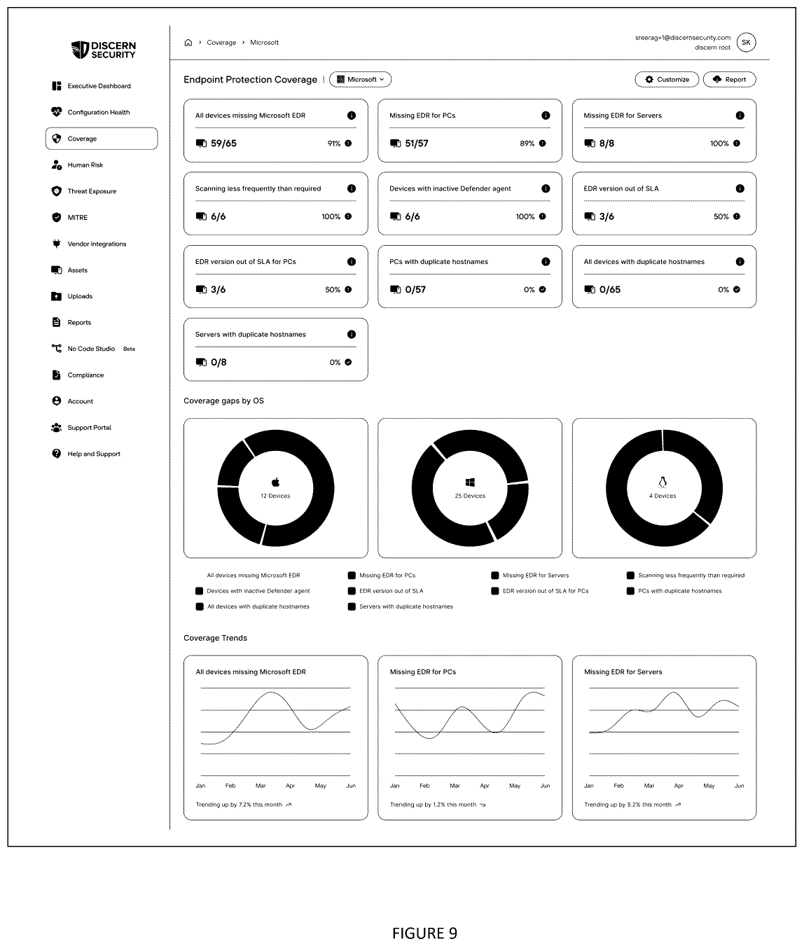

FIG. 9 illustrates an example screenshot of a Coverage Dashboard, according to some embodiments. This provides details about the Security coverage in an organization as well as possible gaps in the installation of security feature.

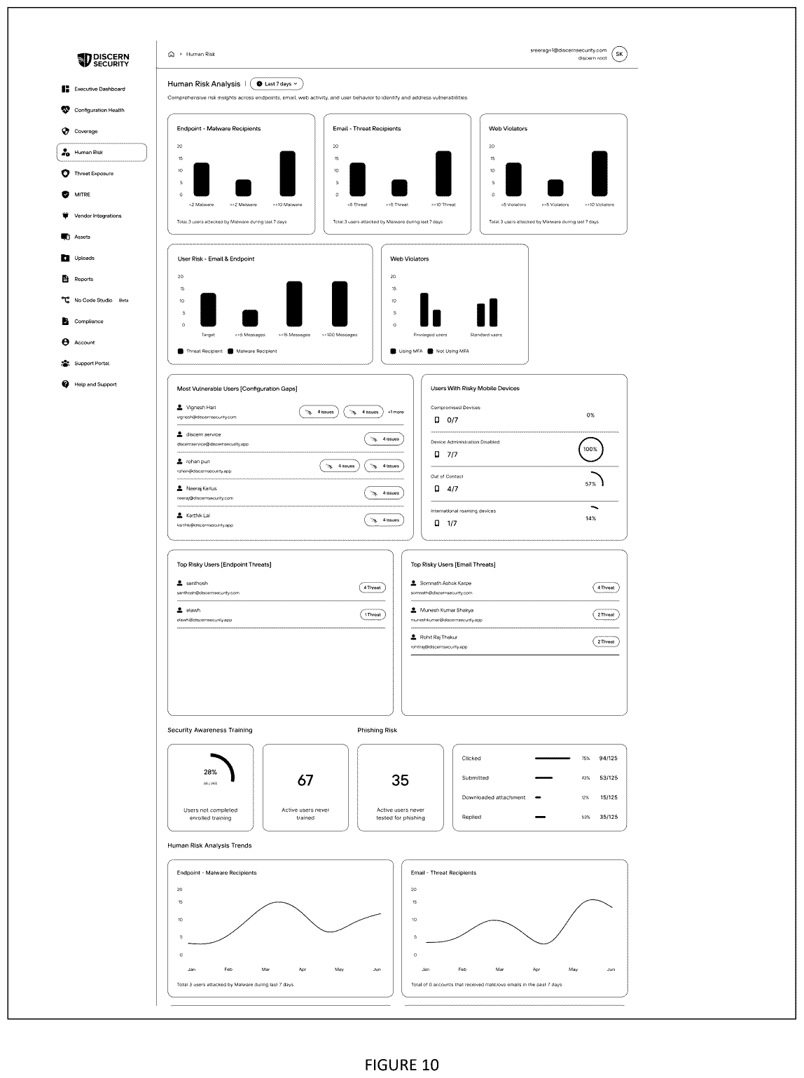

FIG. 10 illustrates an example screenshot of Human risk dashboard, according to some embodiments. FIG. 10 provides details about the most at risk users. It shows various threats targeting employees in the company as well as visibility of employee behavior towards cyber security. It can also show their knowledge about the cyber security and Phishing simulation details.

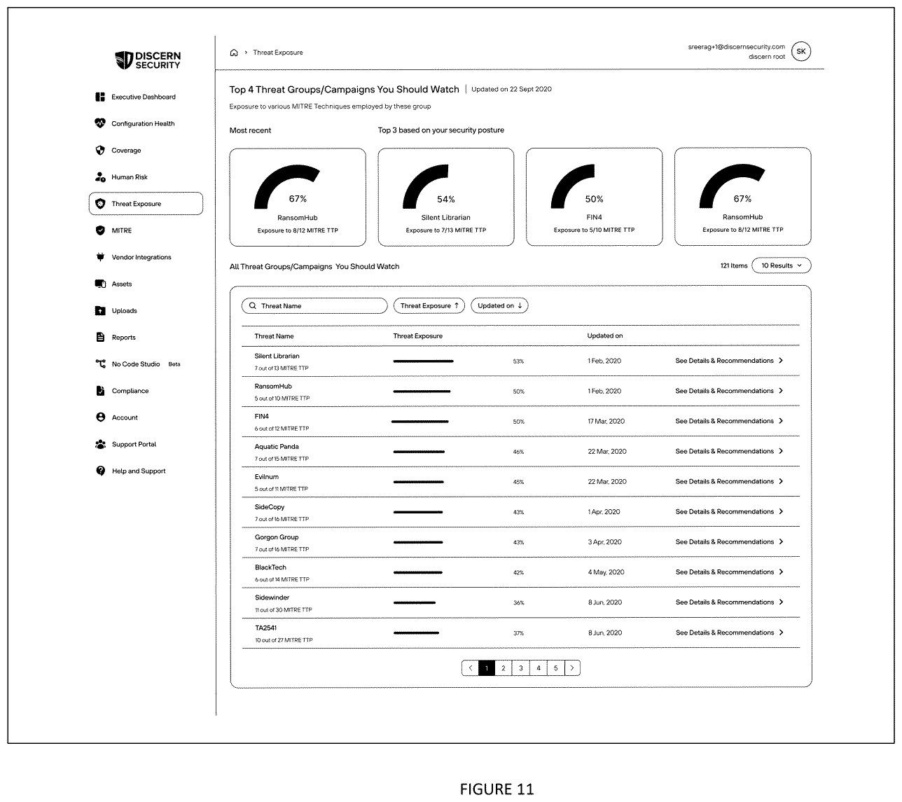

FIG. 11 illustrates an example screenshot of Threat Exposure analysis, according to some embodiments.

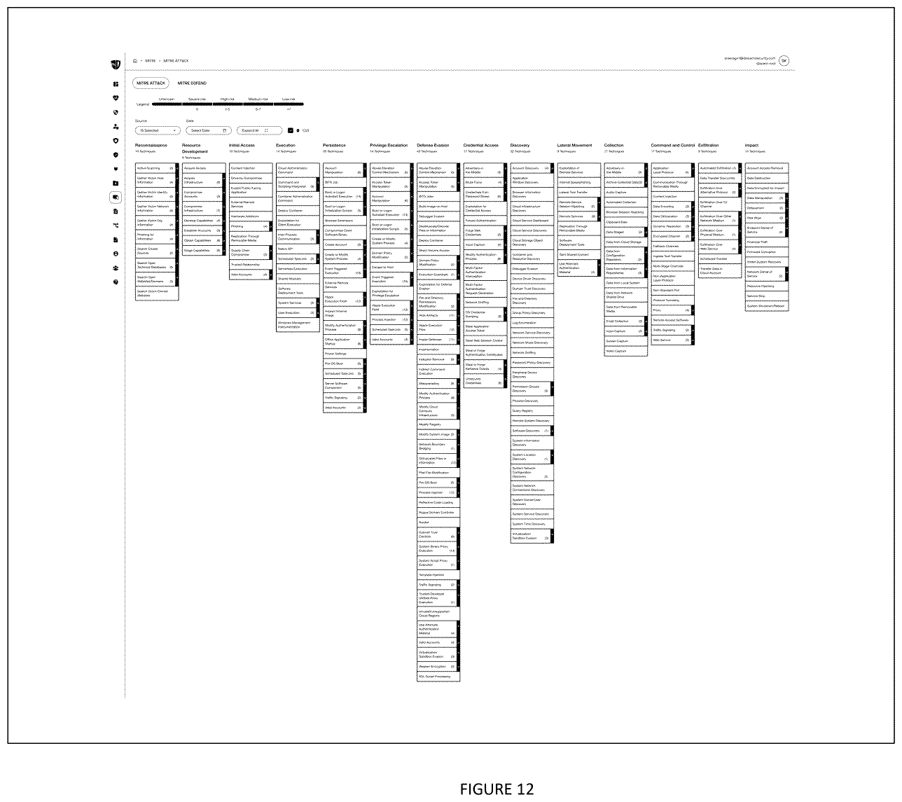

FIG. 12 illustrates an example screenshot of MITRE Attack information, according to some embodiments.

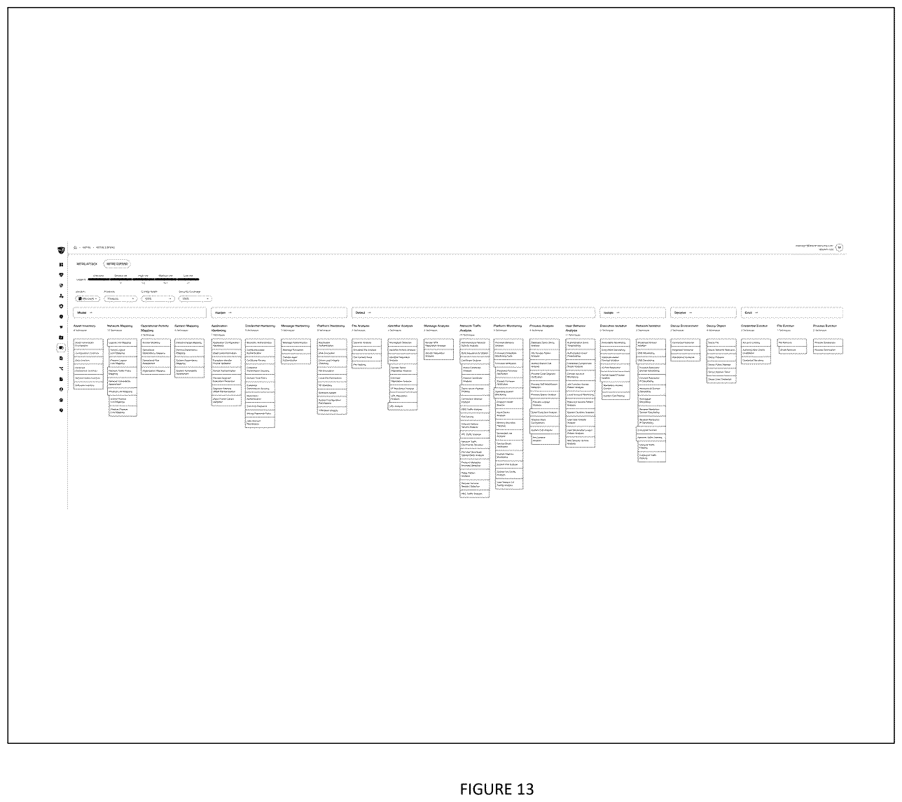

FIG. 13 illustrates an example screenshot of MITRE Defend information, according to some embodiments.

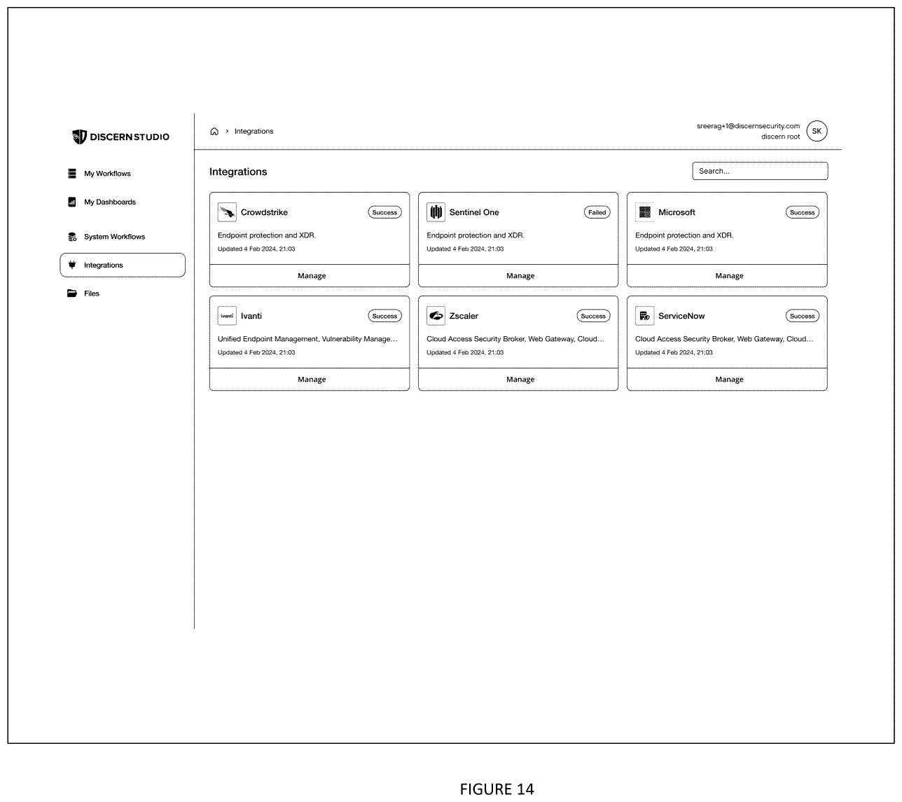

FIG. 14 illustrates an example screenshot of Vendor Integrations, according to some embodiments.

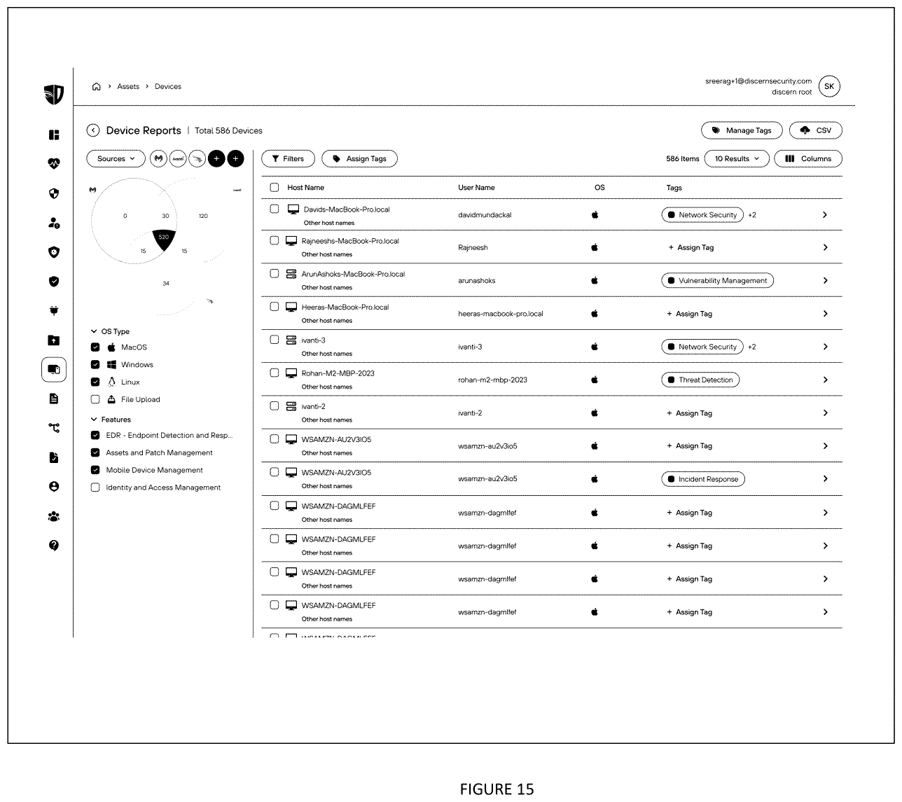

FIG. 15 illustrates an example screenshot of Asset information, according to some embodiments.

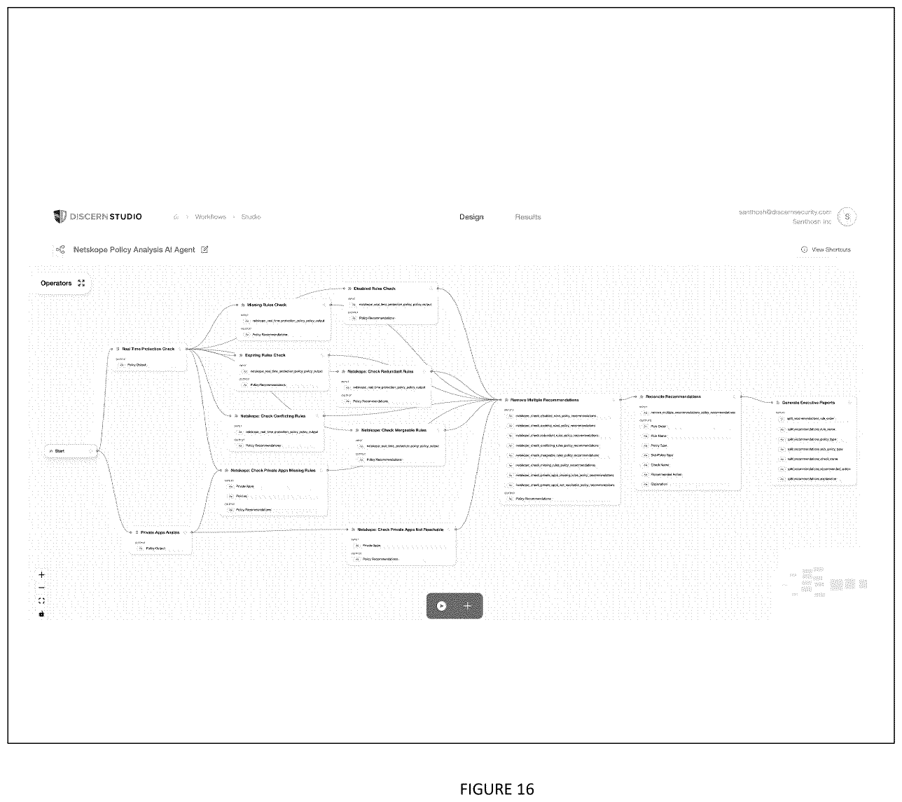

FIG. 16 illustrates an example screenshot of an AI Studio-Work flow Example, according to some embodiments.

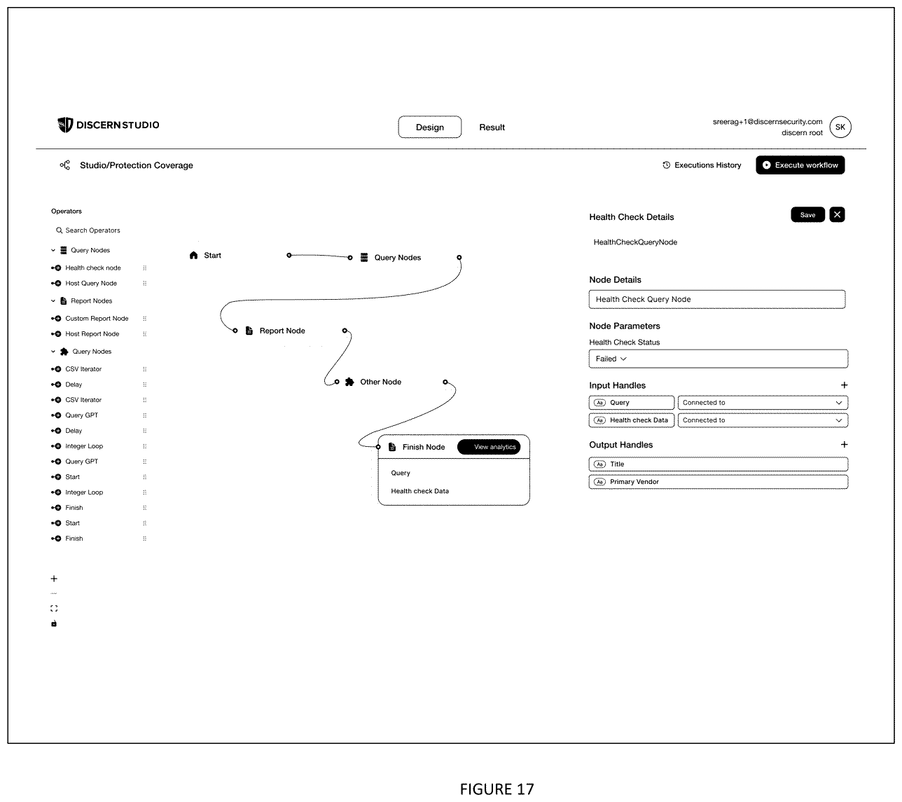

FIG. 17 illustrates an example screenshot of AI Studio-Studio design page, according to some embodiments.

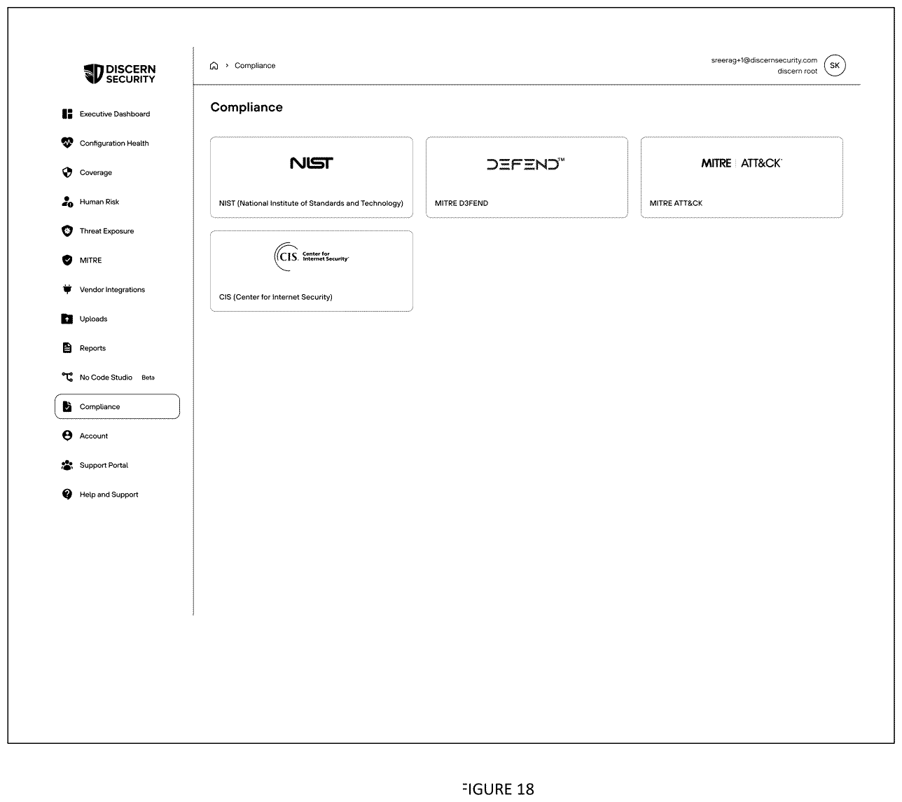

FIG. 18 illustrates an example screenshot of Compliance information, according to some embodiments.

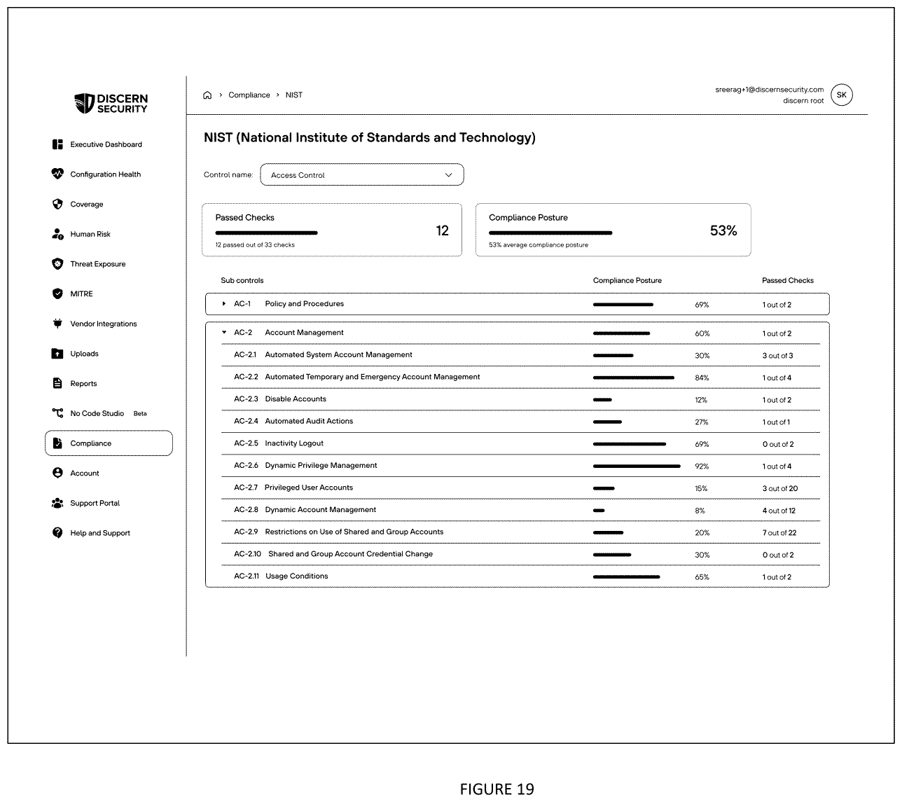

FIG. 19 illustrates an example screenshot of NIST-Compliance information, according to some embodiments.

Example screenshots depict the user interface that allows interaction with the core functionalities of the system. This interface enables users to adjust and set the operational parameters of the system. This can be analogous to a brain of the system in that this interface is used to configure the neural connections within that brain. The effectiveness of the dashboard and other reporting interfaces can be based on these configurations. Additionally, this interface facilitates the integration of various pieces of information to establish new workflows.

A comprehensive cybersecurity management platform can provide endpoint protection, configuration risk assessment, and integration with multiple security vendors. As shown in the screen views of example screenshots, the cybersecurity management platform features an intuitive dashboard-based interface that allows security teams to monitor their organization's security posture, track key metrics, and identify areas for improvement.

This report analyzes the key components and functionality of the Cybersecurity platform based on screenshots of its user interface. It covers the main dashboard views, endpoint analysis capabilities, configuration risk assessment, and integration features. The report also proposes a high-level system architecture and key processes that likely underpin the platform's functionality.

In some embodiments, the cybersecurity management platform can consist of several key modules:
Executive Dashboard: Provides a high-level overview of the organization's security posture;
Endpoint Analysis: Detailed monitoring and analysis of endpoint device protection;
Configuration Risk Assessment: Evaluates security configurations and identifies issues;
Vendor Integrations: Connects with and aggregates data from multiple security products;
Reporting and Analytics: Generates insights and tracks security trends over time.

The cybersecurity platform can use a web-based interface with a consistent layout featuring a navigation menu on the left side and a main content area. The cybersecurity platform can employ data visualizations like charts, graphs, and progress indicators to present key metrics and trends.

An example Executive Dashboard is now discussed by way of example. The Executive Dashboard provides C-level executives and security leaders with an at-a-glance view of the organization's overall security posture. Key features include, inter alia: Total Health Score: An aggregate metric (82% in the example) representing overall security health; Key Performance Indicators (as provided by way of example):
Configuration in place: 70%;
Device Protection Coverage: 50%;
User Risk Coverage: 83%;
User Protection Coverage: 73%;
Top Vendors can be various lists security vendors in use with configuration counts and scores. Coverage Metrics can show device/user counts for key security tools. Top Recommendations can include highlights critical security actions to take. Highlights can include noteworthy security achievements and metrics. A Progress Trend can include charts security posture improvement over time. This dashboard allows executives to quickly assess the organization's security status, identify gaps, and track improvements over time.

Endpoint Analysis is now discussed. The Endpoint Analysis module provides detailed insights into the protection status of endpoint devices across the organization. Key features include, inter alia:
Endpoint Protection Coverage:
Devices with InActive Falcon Sensor: 2.72% (35 out of 6644 devices);
Scanning less frequently: 1.42% (35 out of 6644 devices);
Out of Date Endpoint Protection: 2.12% (35 out of 6644 devices);
EDR version out of SLA: 3.33% (35 out of 6644 devices);
Coverage Gaps by Device Type:
Missing EDR for Work Stations: 4.11% (35 out of 6644 devices);
Missing EDR for Servers: 5.62% (35 out of 6644 devices);
EDR Version out of SLA (Work Station): 3.33% (35 out of 6644 devices); and
EDR Version out of SLA (Server): 1.76% (35 out of 6644 devices).

The module also includes a chart showing coverage gaps by operating system (Mac, Windows, Linux) and trend graphs tracking various endpoint protection metrics over time. This detailed view allows security teams to quickly identify endpoint protection issues and prioritize remediation efforts.

Configuration Risk Assessment is now discussed. The Configuration Risk module evaluates security configurations across the organization's IT infrastructure and highlights potential vulnerabilities. Key features include, inter alia (by way of example):
Overview Metrics:
Total Health Checks: 40;
Successful Health Checks: 23 out of 40 (57.5%);
Failed Health Checks: 23 out of 40 (57.5%);
Disabled Health Checks: 2 out of 40 (5%);
Configuration Improvements: +03;
Open Issues by Severity:
Critical: 32;
High: 35;
Medium: 68; and
Low: 43.

The module also includes a chart tracking created vs. resolved issues over time, allowing teams to assess their progress in addressing configuration risks.

Vendor-Specific Analysis can provide configuration risk assessments for individual security vendors. For example, the CrowdStrike assessment shows, inter alia:
Configuration Improvements: +03;
Total Health Checks: 40;
Successful: 23 out of 40;
Failed: 7 out of 40; and
Disabled: 2 out of 40.

It also includes a detailed table of health checks with status, priority, and impact metrics for each configuration item.

Vendor Integrations are now discussed. The cybersecurity platform integrates with multiple security vendors to aggregate data and provide a unified view of the organization's security posture. Integrated vendors include, inter alia (by way of example):
CrowdStrike: Endpoint protection and XDR;
SentinelOne: Endpoint protection and XDR;
Microsoft: Endpoint protection and XDR;
Ivanti: Unified Endpoint Management, Vulnerability Management; and
Zscaler: Cloud Access Security Broker, Web Gateway, Cloud Firewall.

The cybersecurity platform tracks the status of these integrations (e.g. Success, Failed) and when they were last updated. This integration approach allows organizations to centralize their security management and gain holistic insights across multiple tools.

Key Processes and Workflows are now discussed. Based on the interface screenshots, the cybersecurity platform fan infer several key processes and workflows within the Cybersecurity platform, inter alia (by way of example): an Endpoint Protection Monitoring Process that collects endpoint data from integrated security tools (e.g. CrowdStrike, SentinelOne, etc.). As shown in example screenshots, the cybersecurity platform can analyze endpoint protection status (e.g. active sensors, scanning frequency, version compliance, etc.). The cybersecurity platform can identify protection gaps by device type and operating system. The cybersecurity platform can generate alerts for devices with inadequate protection. The cybersecurity platform can track protection trends over time. The cybersecurity platform can update executive dashboard with endpoint protection metrics.

An example Configuration Risk Assessment Process is now discussed that can be implemented based on the content of example screenshots. The cybersecurity platform can define health checks for various security configurations. The cybersecurity platform can run automated health checks across the IT infrastructure. The cybersecurity platform can categorize results (e.g. Success, Failed, Disabled). The cybersecurity platform can assign severity levels to failed checks (e.g. Critical, High, Medium, Low). The cybersecurity platform can generate detailed reports of configuration issues. The cybersecurity platform can track issue resolution over time. The cybersecurity platform can update Executive Dashboard with configuration risk metrics.

The cybersecurity platform can implement a Security Posture Improvement Workflow. Here, the cybersecurity platform can aggregate data from endpoint protection and configuration risk assessments. The cybersecurity platform can calculate overall health score and key performance indicators. The cybersecurity platform can generate top security recommendations based on identified gaps. The cybersecurity platform can present progress trends and highlights to executive users. The cybersecurity platform can allow drilling down into specific areas (e.g. endpoint analysis, configuration risk) for detailed investigation. The cybersecurity platform can facilitate creation of remediation tasks based on identified issues.

A cybersecurity platform that provides threat intelligence, workflow automation, and user risk analysis. The cybersecurity platform features an intuitive dashboard-based interface that allows security teams to monitor their organization's security posture, track key metrics, and identify areas for improvement.

This report analyzes the key components and functionality of the Cybersecurity platform based on screenshots of its user interface. It covers the main features including workflow management, threat exposure analysis, and user risk assessment. The report also proposes high-level process flows and a system architecture that likely underpin the platform's functionality.

The cybersecurity platform consists of additional key modules in addition to those described supra. These can include, inter alia:
My Workflows: Custom workflow creation and management;
Studio/Protection Coverage: Visual workflow design tool;
Threat Exposure: Analysis of potential security threats; and
User Risk Analysis: Assessment of user-related security risks.

The cybersecurity platform can implement Configuration Risk. In additional to the functionalities described supra, the Executive Dashboard can perform various Integrations. The cybersecurity platform uses a web-based interface with a consistent layout featuring a navigation menu on the left side and a main content area. It employs data visualizations like charts, graphs, and progress indicators to present key metrics and trends.

The cybersecurity platform can implement additional Workflow Management. The Workflows List provides an overview of custom workflows created within the cybersecurity platform. Key features can include:
Search functionality for finding specific workflows;
Creation date and last update information;
Execution count for each workflow;
Tags for categorizing workflows (e.g., created_by, demo, vendors_db); and
Options to create new workflows and view execution history.

Notable workflows visible in the screenshot can include:
Security score calculations (e.g., sooryan-ms_secure_score-mitre-ma . . . );
Risk remediation workflows (e.g., vinay-sophos-risk-remediation-descr . . . );
MITRE ATTand CK related workflows (e.g., heera-sophos-hc-mitreattackv14-mit . . . ); and
Analytics and visualization workflows (e.g., santhosh-hc-category-visualization).

Studio/Protection Coverage is now discussed. The Studio/Protection Coverage module provides a visual workflow design tool for creating custom security workflows. Key features can include:
Drag-and-drop interface for connecting workflow nodes;
Library of pre-built operators and nodes (e.g., Health check node, Host Query Node, Custom Report Node);
Ability to customize node parameters and connections; and
Options to save, view execution history, and execute workflows.

Example screenshots show an example workflow that demonstrates a simple health check process that is now discussed. This can include, inter alia: Start node; Health Check Details node; Inputs: Query and Health check Data; Outputs: Title and Primary Vendor; Configurable parameters like Health Check Status; etc. A visual workflow designer allows security teams to create complex, custom processes without extensive coding knowledge.

Threat Exposure Analysis is also provided by the cybersecurity platform. The Threat Exposure module provides detailed information about potential security threats facing the organization. Key features can include:
List of threat groups/campaigns to watch;
Detailed descriptions of each threat, including their tactics and targets;
Exposure metrics based on MITRE ATT and CK techniques;
Options to filter threats by industry and region; and
Ability to view details and recommendations for each threat;
Notable threats highlighted in the example screenshots of example screenshots include:
Ransomware: Black Basta;
Emerged in 2022, uses Ransomware-as-a-Service (RaaS) model;
Exposure to 4 out of 40 MITRE Techniques;
DNS Infrastructure Hijacking;
Targets government agencies, large corporations, and financial institutions;
Exposure to 16 out of 20 MITRE Techniques;
Ransomware: Akira Ransomware;
Identified in 2023, specializes in encrypting data on compromised systems; and
Exposure to 24 out of 32 MITRE Techniques.

The cybersecurity platform provides a summary view showing the top threats based on the organization's security posture, with visual indicators of coverage against each threat. User Risk Analysis can be performed as well. The User Risk Analysis module provides a comprehensive overview of user-related security risks within the organization. Key features include:
Endpoint and Email security metrics;
Web violation statistics;
User risk assessment for email and endpoint security;
Multi-Factor Authentication (MFA) activation status;
List of most vulnerable users with configuration gaps;
Statistics on risky mobile devices;
Top risky users for endpoint and email threats; and
Trend analysis for various risk factors;
Notable metrics and visualizations can include, inter alia: Malware, spam, and web violation recipients/incidents; comparison of spam recipients vs. malware recipients; MFA activation rates for privileged and standard users; Detailed list of vulnerable users with specific configuration gaps; Mobile device risk factors (compromised, disabled administration, out of contact); Trend graphs for malware recipients, spam recipients, and MFA activation; etc.

Based on the interface screenshots, the cybersecurity platform can infer several key processes and workflows within the Cybersecurity platform. A User can navigate to “My Workflows” section. The User creates a new workflow or selects an existing one. In the Studio/Protection Coverage module, user designs the workflow: a. Drag and drop nodes from the Operators panel b. Configure node parameters and connections c. Save the workflow, etc. The User executes the workflow as well. The results are displayed and stored for future reference.

An example Threat Exposure Assessment Process as shown in example screenshots is now discussed. The cybersecurity platform aggregates threat intelligence from various sources. Threats are categorized and associated with MITRE ATT and CK techniques. The cybersecurity platform analyzes organization's security posture against known threats. The exposure levels are calculated based on implemented security measures. Threats are prioritized based on exposure and potential impact. The cybersecurity platform generates recommendations for improving defense against top threats.

An example User Risk Analysis Process of the cybersecurity platform is now discussed. Again, this is shown in example screenshots. The cybersecurity platform can collects data from various security tools (e.g. endpoint protection, email security, web filters). Data is aggregated and analyzed to identify risk patterns. The cybersecurity platform calculates risk scores for individual users based on multiple factors. High-risk users and behaviors are flagged for review. Trend analysis is performed to identify emerging risks. The cybersecurity platform generates reports and visualizations of user risk data.

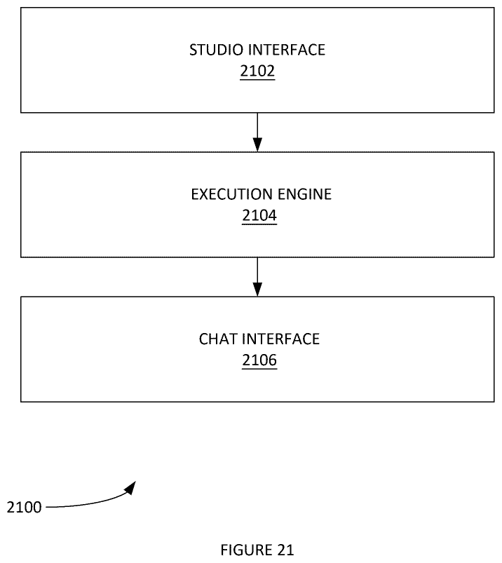

FIG. 21 illustrates an example system 2100 that features a dual-interface design for enhanced workflow management, according to some embodiments. The first component is the studio interface 2102 (e.g. see applicable screen shot, etc.). Studio interface 2102 can be a user-friendly UI where experts can author and design workflows. These workflows are composed of interconnected, actionable nodes that perform specific tasks, from data retrieval to complex analysis.

The second component is an execution engine 2104. Execution engine 2104 can deploy these workflows either immediately or at scheduled intervals, or even trigger them based on specific conditions, such as detecting a configuration change. This ensures that workflows are dynamically responsive to operational needs.

Additionally, the system includes a chat interface 2106. Chat interface 2106 can provide an interface where experts can quickly draft workflows through interactions with a bot. This conversational approach allows experts to input their specialized knowledge directly, which the bot uses to construct workflows. Experts can then review and refine each node within the workflow for accuracy, ensuring the system's actions are both precise and effective. This comprehensive setup not only streamlines workflow creation but also enhances adaptability and responsiveness to changing security environments.

Human interactions with a dynamic cybersecurity policy management based on contextual adaptive learning system (e.g. system 700, etc.) are now discussed. The system can implement, inter alia: Personas Interacting with the system; SOC operations; End user employees; IT Specialists who are subject matter experts who can create best practices and review the effectiveness of these. Global Analysts can utilize the system for creating system-level health checks, creating, review HC and Policy recommendations, review AI recommendations, and analyze the effectiveness of these and fine tube LLMs, Prompts, etc. FIG. 13 illustrates an example SOC input to the system for recommendations, according to some embodiments. The SOC administrator has chosen to accept the risks or plan to implement the risks.

Risk visibility and framework mapping is now discussed. Risk visibility and framework mapping can provide risk visibility in an easily understandable way (e.g. red, yellow-green color coding for the MITRE framework, etc.). A detailed explanation of how this risk is calculated and details about the control gaps contributing to that risk. Screenshot 1400 shows a sample of controls/configurations mapping to MITRE Defend. As shown, various security controls in a customer environment mapped to a standard framework (e.g. MITRE DEFEND, etc.) to provide visibility of various security control in an environment against cyberattacks. Various color-coding schemes can be used to provide visibility to the risks of controls and gaps in configuration etc.

Policy automation is now discussed. Policy automation provides the ability to fully execute a policy change. This can be detailed information via a service ticket or calling a vendor API and executing the change or giving instructions to some other system responsible for policy change in the organization.

### Additional Example Computer Architecture and Systems

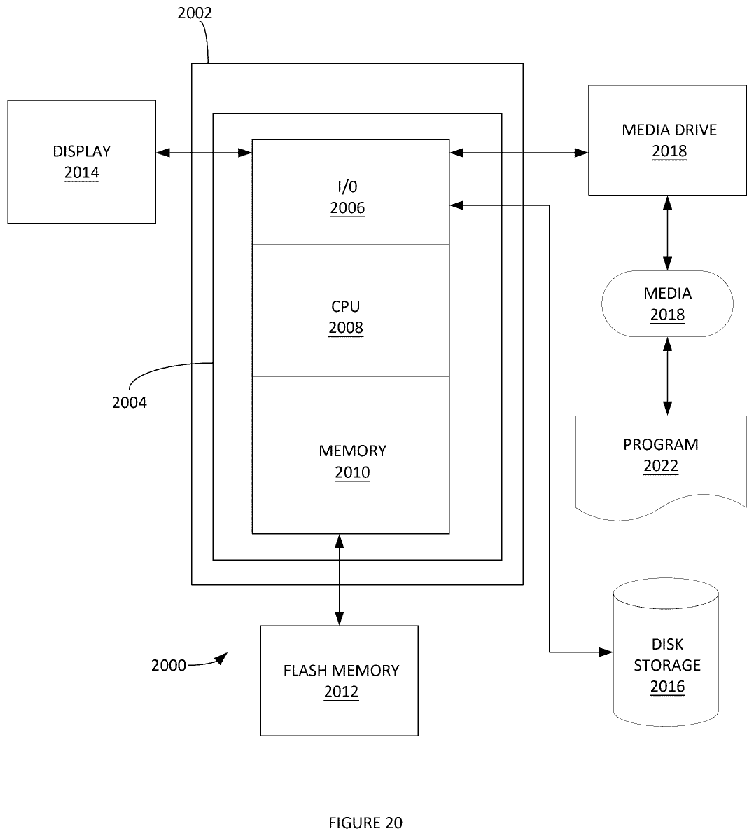

FIG. 20 depicts an exemplary computing system 2000 that can be configured to perform any one of the processes provided herein. In this context, computing system 2000 may include, for example, a processor, memory, storage, and I/O devices (e.g., monitor, keyboard, disk drive, Internet connection, etc.). However, computing system 2000 may include circuitry or other specialized hardware for carrying out some or all aspects of the processes. In some operational settings, computing system 2000 may be configured as a system that includes one or more units, each of which is configured to carry out some aspects of the processes either in software, hardware, or some combination thereof.

FIG. 20 depicts computing system 2000 with a number of components that may be used to perform any of the processes described herein. The main system 2002 includes a motherboard 2004 having an I/O section 2006, one or more central processing units (CPU) 2008, and a memory section 2010, which may have a flash memory card 2012 related to it. The I/O section 2006 can be connected to a display 2014, a keyboard and/or other user input (not shown), a disk storage unit 2016, and a media drive unit 2018. The media drive unit 2018 can read/write a computer-readable medium 2020, which can contain programs 2022 and/or data. Computing system 2000 can include a web browser. Moreover, it is noted that computing system 2000 can be configured to include additional systems in order to fulfill various functionalities. Computing system 2000 can communicate with other computing devices based on various computer communication protocols such a Wi-Fi, Bluetooth® (and/or other standards for exchanging data over short distances includes those using short-wavelength radio transmissions), USB, Ethernet, cellular, an ultrasonic local area communication protocol, etc.

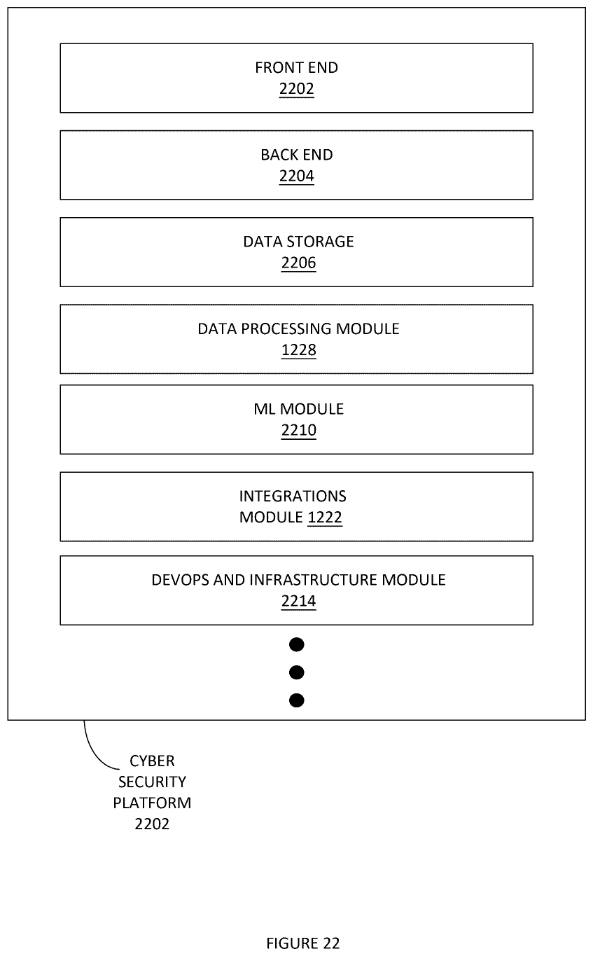

FIG. 22 illustrates an example system for implementing a cyber security platform 2200, according to some embodiments. Frontend 2202 can include various functionalities. These can include a Web Application. The Web Application can implement React-based single-page application (SPA) for the user interface. Frontend 2202 can include a Data Visualization Library for creating interactive charts and graphs. Frontend 2202 can include State Management systems for managing application state. UI Component Library can be used for consistent styling. A Workflow Designer can manage Custom React components for the visual workflow builder.

Backend 2204 can include an API Gateway that manages authentication and routes requests to appropriate microservices. Backend 2204 can include various Microservices, including, inter alia: User Management Service; Workflow Management Service; Threat Intelligence Service; User Risk Analysis Service; Configuration Management Service; Reporting Service; etc. A Message Queue can be used for asynchronous processing. A Workflow Execution Engine can implement custom service for processing and executing user-defined workflows. A Caching Layer can be used for improving performance of frequently accessed data.

Data Storage 2206 can include an Relational Database for structured data (e.g. user accounts, configurations). A Document Database can be used for storing unstructured data (e.g. threat intelligence, workflow definitions). A Time-Series Database can be used for storing historical metrics and trends.

Data Processing module 2208 can implement an ETL Pipeline for extracting, transforming, and loading data from various sources. Stream Processing can be used for real-time data analysis. Batch Processing can be used for large-scale data processing and analytics.

Machine Learning module 2210 can implement a ML Pipeline. This can also be used for orchestrating machine learning workflows. Model Serving can be performed for deploying and managing machine learning models (e.g. for risk scoring).

An Integrations module 2212 can manage/provide API Connectors. These can enable custom connectors for integrating with various security tools and data sources. Webhook Support for real-time data ingestion from external systems can be provided.

A DevOps and Infrastructure module 2214 can manage containerization with Docker for packaging applications and dependencies. DevOps and Infrastructure module 2214 can Orchestration via Kubernetes for managing containerized services. CI/CD can be implemented for automated testing and deployment. Monitoring can be implemented for system monitoring and alerting. Logging can be implemented for log aggregation and analysis This architecture can provide the scalability, flexibility, and performance required to handle large volumes of security data from multiple sources, perform complex analyses, and deliver real-time insights through the web interface.

Cyber security platform 2200 can be configured for dynamic cybersecurity policy using AI-based contextual adaptive learning includes an AI system that evaluates business contexts, risk tolerance, and productivity impact to generate threat intelligence assessments. Cyber security platform 2200 includes a Contextual Adaptive Learning module that dynamically adjusts cybersecurity policies based on threat assessments to create security workflows. Cyber security platform 2200 includes a Cybersecurity Mesh Development module that integrates policies across security frameworks. A Dynamic Scenario Catalog module that updates policy adjustments based on threat intelligence. Cyber security platform 2200 includes an Automated Workflow Orchestration module that creates and refines security workflows for optimal efficiency. Cyber security platform 2200 includes a Policy Recommendation and Automation module that generates prioritized security recommendations and automates policy changes based on organizational risk profiles and current security controls. Cyber security platform 2200 includes a harmonizes security policies while considering business context, risk, and productivity impacts.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed is:

1. A computerized system for dynamic cybersecurity policy utilizing with an AI-based contextual adaptive learning system comprising:
wherein the AI-based contextual adaptive learning system incorporates specific a plurality of business contexts, a risk tolerance value, and a productivity impact value to generate a threat intelligence assessment;
a Contextual Adaptive Learning module configured to dynamically adjusting a plurality of cybersecurity policies based on the threat intelligence assessment, wherein the plurality of cybersecurity policies are used to generate a plurality of security workflows, and wherein the plurality of security workflows take into account the plurality of business contexts, the risk tolerance value, and the productivity impact value;
a Cybersecurity Mesh Development module configured to integrate and harmonizes the plurality of plurality of cybersecurity policies across a plurality of security frameworks to create a unified cybersecurity mesh;
a Dynamic Scenario Catalog module configured to continuously generate and update a dynamic scenario catalog that implements a plurality of adaptive policy adjustments and responses based on the threat intelligence assessment;
an Automated Workflow Orchestration module configured to use one or more automated adaptive learning functionalities to automatically create, execute, and refine the plurality of security workflows based on an evolving security scenario such that operational efficiency and response times are optimized; and
a Policy Recommendation and Automation module configured to generate a plurality of prioritized security policy recommendations using the one or more automated adaptive learning functionalities combined configured to automate a plurality of policy changes based on an organizational risk profile and a plurality of current security controls.

2. The computerized system of claim 1 further comprising:
a Human-AI Interaction module configured to integrate an AI-driven policy management with human oversight.

3. The computerized system of claim 2, wherein the Human-AI Interaction module is configured to enable a security professional to review, approve, and customize a plurality of AI-generated policy changes thereby enhancing adaptability and decision-making flexibility.

4. The computerized system of claim 3 further comprising:
an Integrated Threat Intelligence module configured to dynamically adjust the plurality of cybersecurity policies by incorporating a real-time threat intelligence and contextual data from various sources, including internal and external environments, to optimize a specified security posture.

5. The computerized system of claim 4 further comprising:
a Centralized Policy Management Hub module configure to provide real-time visibility and management of the plurality of cybersecurity policies.

6. The computerized system of claim 5, wherein the Centralized Policy Management Hub module to configure to provide real-time visibility and management of the plurality of cybersecurity policies are provided across a plurality of products and vendors to ensure an integrated and coherent security strategy.

7. The computerized system of claim 6 further comprising:
an Adaptive Learning System configured to interface with a Generative AI system.

8. The computerized system of claim 7, wherein the Adaptive Learning System is configured to learn about a vendor configuration and a plurality dependencies of the vendor configuration determined from a plurality of knowledge sources of the vendor configuration.

9. The computerized system of claim 8, wherein the plurality of knowledge sources comprises a vendor documentation source, a vendor support system source, a vendor public forum source.

10. The computerized system of claim 9, wherein the Adaptive Learning System is configured to collect and store the he plurality of knowledge sources into long-term memory, and wherein the plurality of knowledge sources.

11. The computerized system of claim 10, wherein the plurality of security frameworks comprises a MITRE ATT and CK framework.

12. The computerized system of claim 10, wherein the plurality of security frameworks comprises NIST framework.

13. A system for cybersecurity management based on contextual adaptive learning, comprising:
an interface layer comprising a UI portal, an API component, and an AI chatbot;
a memory layer comprising a vector database, a large language model component, a relational database, and a file storage system; and
a business layer operatively coupled to the interface layer and the memory layer, the business layer comprising:
an exposure management recommendations component configured to analyze cybersecurity threats;
a security insights component configured to provide visibility into security posture;
an exposure validation and prioritization component;
a remediation automation component;
a workflow orchestration and execution engine configured to manage automation and execution of security workflows;
an adaptive learning system and recommendation engine configured to power contextual recommendations; and
a data collection and context extraction system configured to process raw data into structured, contextualized information, and
wherein the system is configured to continuously refine security control settings based on an organization's risk posture and appetite.

14. The system of claim 13, wherein the workflow orchestration and execution engine comprises:
a workflow orchestration server configured to manage workflow lifecycle;
a workflow execution engine configured to coordinate execution of individual nodes; a node executor configured to execute discrete business logic tasks;
a data store configured to serve as permanent storage for workflows;
an intermediate store configured to hold data generated during workflow execution;
a data analysis store configured to store final output of workflow executions; and
a data analyzer service configured to provide visual representation of workflows.

15. The system of claim 14, wherein the adaptive learning system and recommendation engine comprises:
a feedback processing system configured to handle human feedback and system-level feedback;
a prioritization input component configured to synthesize business factors and security considerations;
a business logic layer configured to process business use cases;
a knowledge base configured to store extracted knowledge in structured formats; and
an LLM core component comprising a security fine-tuned LLM, a prompt library, and AI agents.

16. The system of claim 15, wherein the data collection and context extraction system comprises:
a data ingestion component configured to process structured and unstructured data;
an NLP context extraction component configured to leverage Natural Language Processing; and
a contextualization component configured to transform ingested data into actionable contexts;
wherein the system is configured to process both dynamic context data and static knowledge data.

17. The system of claim 16, wherein the system is configured to:
integrate with security tools including Zscaler, CrowdStrike, Netskope, and Mimecast;
implement cross-vendor mesh capabilities for coordinated security responses; and
support progressive deployment models for gradual functionality expansion.

18. The system of claim 17, wherein the system implements:
quality assurance mechanisms with multiple validation checks; comprehensive audit and compliance capabilities with detailed logging; and
role-based access control for managing system access and capabilities.
